(19) United States
(12) Patent Application Publication
(10) Pub. No.: US 2004/0002052 A1
(43) Pub. Date: Jan. 1, 2004

(54) Systems and methods for rapid evaluation and design of molecules for predicted biological activity

(76) Inventor: Lawrence B. Hendry, Augusta, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/279,546

(22) Filed: Oct. 23, 2002

Related U.S. Application Data
(60) Provisional application No. 60/344,560, filed on Oct. 23, 2001.
(60) Provisional application No. 60/339,954, filed on Dec. 10, 2001.

(51) Int. Cl. A01N 1/00

(52) U.S. Cl. 435/1.1

(57) ABSTRACT

The computer-based systems and methods are for rapidly evaluating molecules for suspected biological activity and relative potency, and for designing molecules for desired biological activity. The systems and methods enable rapid screening of large molecular databases using one or more search engines designed to identify molecules predicted to possess specific biological activities.

### PRIOR RELATED APPLICATIONS

This patent application claims priority to U.S. provisional patent applications serial No. 60/344,560 filed Oct. 23, 2001 and No. 60/339,954 filed Dec. 10, 2001.

### FIELD OF THE INVENTION

The present invention relates generally to computer-based systems and methods for rapidly evaluating and designing molecules for predicted biological activity.

### BACKGROUND OF THE INVENTION

Rapid development of advanced computing speed and software has greatly improved the ability of individuals to create models of molecules and to manipulate them by rotating bonds and examining electrostatic interactions of the molecules and their associated conformations with other molecules.

The process of drug development is extremely expensive and slow. It is not uncommon for the entire costs of developing a new drug, obtaining approval from regulatory agencies like the Food and Drug Administration (FDA), and introducing the drug into the market to exceed $800 million US dollars. After such massive expenditures, a new therapeutic may exhibit unacceptable side effects, resulting in removal of the drug from the market and loss of the development costs. What is needed is a more efficient and cost-effective method for designing drugs of desired biological activity. What is also needed is a method which predicts potential deleterious effects of a designed drug during the development stage, before the drug is synthesized, purified, tested in biological systems and introduced into recipients such as animals, humans, plants or insects.

Numerous molecules have been synthesized by chemists working in laboratories in universities and in companies, such as pharmaceutical companies. Many of these molecules are well characterized chemically, however their biological function either remains unknown or is suspected. Occasionally, one particular biological function for a substance has been discovered although there is no effective and rapid method for predicting potential other biological functions for the substance. At the present time, other than high throughput screening, there is no method for rapidly evaluating compounds of unknown biological activity for one or more suspected biological activities. In fact, there is no rational method for choosing one or more specific biological activities for further evaluating a molecule of unknown activity.

A major drawback of high throughput screening is that it requires that the molecules being evaluated are already synthesized. Moreover, determining which high throughput assay correlates with a given target biological activity can be difficult. For example, screens utilizing receptor proteins whose binding does not correlate with biological activity can miss active compounds and/or select compounds with little or no biological activity. Even though it is possible to screen thousands of molecules rapidly, the structures of molecules which are identified by or hit the screen are extremely limited due to constraints posed by what molecular structures are physically available.

Another way to develop active molecules is to employ combinatorial chemistry. Combinatorial chemistry utilizes a given template of molecular fragments and existing chemical reactions to produce mixtures containing large numbers of structures. In practice, combinatorial chemistry is limited by the starting fragments, the nature of the chemical reactions, the feasibility of synthesis and the ability to sort out which compounds in the reaction mixtures may or may not be active. The choice of the starting structural template severely limits the chemical entities eventually produced. While useful in creating large numbers of compounds, the question remains as to which initial template is likely to give rise to active structures. For example, if one were attempting to create a new anti-inflammatory drug and the original template was tetracycline, it would not be possible to synthesize steroids, such as dexamethasone, which are known to have potent anti-inflammatory activity.

Even when a molecule is known to display a specific biological activity, there is no rational method for choosing or evaluating one or more specific additional biological activities that could be possessed by the molecule. One example of a substance possessing a known biological activity, and later demonstrating an additional biological activity is a pesticide which was later shown to deleteriously affect the reproductive system of turtles, to impact their fertility and decrease the number of offspring.

Testing of molecules for suspected biological activity is an enormous task requiring tremendous resources. What is needed is a system that can rapidly evaluate molecules for possession of new biological activities. What is further needed is a method which predicts unacceptable biological side effects of molecules. Such a method would reveal new biological activities for existing molecules, predict unacceptable side effects of molecules and result in new uses for existing molecules.

Numerous databases contain hundreds of thousands or millions of molecules of unknown biological activity, as well as substances of known or suspected biological activity. Such databases include, but are not limited to the National Cancer Institute database, the Maybridge database, Chemnavigator, Merck Index, World Drug Index, and the Physician's Desk Reference (PDR). In addition, numerous manufacturers of chemical and biological molecules provide computer accessible databases containing structural information concerning known molecules. These databases include but are not limited to SIGMA, ALDRICH, Phoenix, Maybridge, Molecular Probes, Calbiochem, Chemnavigator, and Molecular Design Limited (MDL). Many of these and other databases are accessible through the Internet and are known to one of ordinary skill in the art. New information concerning predicted biological activities of the molecules in these databases would reveal new uses for these molecules, their potential side effects in other biological systems, and potential deleterious or toxic effects of these molecules. Such information would greatly decrease the costs of developing new cosmetic, prophylactic, nutritional and therapeutic molecules. This information would also save resources by providing a list of candidate molecules, predicted to possess one or more biological activities, for biological testing.

The public health and welfare requires new tools for rapidly identifying molecules and rapidly designing molecules that possess a desired biological activity. Such molecules are needed for numerous biological activities and therapeutic applications, including but not limited to hormonal treatment, treatments for impotence, anti-cancer therapy, sedative treatment, anti-depressant treatment, treatment for bone loss, as anti-angiogenic agents and others. Infectious disease remains a major health threat to modern society and new pharmaceutical solutions are needed. For example, new molecules are needed that are capable of fighting disease, such as anthrax. Such molecules may be designed de novo or identified from existing databases, but methods for accomplishing these goals remain tedious, expensive and cumbersome. What is needed are new approaches for rapidly identifying molecules, such as antibiotics, that may combat infectious disease, such as anthrax. Also needed are efficacious antibiotics, in view of the increasing number of antibiotic-resistant organisms.

Accordingly, what is needed is a computer-based system and method which has the capability to rapidly evaluate molecules for predicting that the molecules possess one or more biological activities.

In addition, what is needed is a computer-based system and method which has the capability to rapidly evaluate numerous molecules for predicting that the molecules possess one or more biological activities.

What is also needed is a computer-based system and method which has the capability to rapidly evaluate numerous molecules in databases for predicting that the molecules possess one or more biological activities.

Also needed is a computer-based system and method which facilitates design of molecules predicted to possess a specific biological activity.

What is also needed is a computer-based system and method which facilitates de novo design of molecules predicted to possess a specific biological activity.

In addition, what is needed is a computer-based system and method which has the capability to predict the degree of biological activity of a molecule

What is needed is a computer-based system and method which has the capability to rapidly evaluate numerous molecules in large molecular databases for predicting that the molecules possess one or more biological activities by accessing these databases through a network, such as the Internet.

### SUMMARY OF THE INVENTION

The present invention addresses the problems described above by providing new, effective and efficient computer-based systems and methods for in silico evaluation of known molecules for predicted biological activity and for in silico design of new molecules to possess a selected biological activity. The present invention provides computer-based systems and methods for rapid evaluation of numerous molecules. The present invention also provides computer-based systems and methods for rapidly accessing databases and evaluating molecules contained therein for predicted biological activity. The novel search engines of the present invention significantly reduce the cost of developing new molecules for therapeutic, cosmetic, prophylactic, nutritional and other uses. New uses for known molecules are also revealed through use of the novel search engines of the present invention.

A system and method according to an embodiment of the invention permit rapid access to these databases and evaluation of molecules for possessing one or more predicted biological activities. Such evaluations include molecules of unknown biological activity, evaluations of molecules of suspected biological activity, and of molecules of known biological activity. It is to be understood that both molecules of predicted biological activity and molecules of known biological activity can be rapidly evaluated to determine their likelihood of possessing other biological activities through the use of the system and method.

The use of this method facilitates prediction of new biological activities for molecules of unknown biological activity, known biological activity or suspected biological activity. The method of the present invention also permits prediction of the relative biological activity of a molecule when compared to an index molecule of known biological activity.

The use of the method permits prediction of biological activity and facilitates efficient and focused biological testing of the molecule for the predicted activity. The use of the method provides new insight into the biological activity of molecules, thereby providing new uses for substances of unknown biological activity, new uses for molecules of known biological activity and also identifies potentially toxic effects of these molecules.

According to one aspect, a method for rapidly evaluating the potential biological activity or activities of a molecule, comprises:

a) obtaining information concerning the structure and electrostatic profile of a molecule;

b) determining if the molecule will fit electrostatically and sterically into one or more constructs configured in a search engine. One construct is hereinafter called a spatial. The spatial comprises a three dimensional representation of electrostatic charges of defined shape, orientation and field strength, wherein the three dimensional representation is related to defined loci in space derived from heteroatoms on nucleic acids, nucleic acid/protein complexes, nucleic acids bound to water, or nucleic acid/protein complexes bound to water, and their bonding relationship to heteroatoms on one or more molecules of known biological activity, wherein one or more spatials is or are associated with a specific biological activity;

c) evaluating the fit of the molecule into the spatial, wherein if the molecule fits into the spatial, then the molecule would be a candidate to possess the biological activity.

In a preferred embodiment, the information concerning the molecule is obtained from a database containing the structure of the molecule.

In one embodiment of the present invention, the database is located with the search engine.

In another preferred embodiment of the present invention, the database is located outside the search engine and is accessed remotely.

In a preferred embodiment of the present invention, the database is located outside the search engine and is accessed through a network, wherein the network provides access to the database through the Internet.

In another embodiment, the search engine, and or components thereof, may be sent through the Internet to other sites for the purpose of searching those sites.

In a preferred embodiment of the present invention, the database is located outside the search engine and is accessed through a network, wherein the network provides access to the database through the Internet or through a local area network, and wherein such access is accomplished rapidly, permitting access to and evaluation of numerous molecules in the database for potential biological activity.

The spatial is designed using one molecule or more than one molecule of known biological activity through a method comprising:

a) selecting a site in the nucleic acid, nucleic acid/protein complex, water/nucleic acid complex, or water nucleic acid/protein complex which accommodates the one or more molecules of known biological activity;

b) determining the heteroatoms on the nucleic acid, nucleic acid/protein complex, water/nucleic acid complex, or water nucleic acid/protein complex, and on the molecule or molecules of known biological activity likely to form hydrogen bonds;

c) determining the strength and orientation (directionality) of electrostatic charges associated with the heteroatoms;

d) establishing a range of acceptable distances from each heteroatom on the nucleic acid for interaction with the heteroatoms on the molecule of known biological activity;

e) defining the range of acceptable distances from each heteroatom on the nucleic acid for interaction with the heteroatoms on the molecule of known biological activity as a “spatial”; and,

f) configuring the one or more spatials associated with the nucleic acid and the one or more molecules of known biological activity in a search engine, so that the one or more spatials define criteria for evaluating a molecule of unknown biological activity, wherein if heteroatoms of a molecule of unknown biological activity fit within the spatial, then the molecule would be predicted to possess the biological activity.

A second criterion which may be employed in the method of using a search engine is a Connolly surface. A Connolly surface is created as the composite shape of the one or more molecules of known biological activity used in the formation of the spatial, when heteroatoms on such molecules are properly oriented in their bonding relationship to heteroatoms on nucleic acids. The Connolly surface may be expanded or contracted by selected distances, usually in angstroms, in order to expand or restrict the number of molecules which may fit within the Connolly surface. Molecules, when properly oriented relative to heteroatoms on the nucleic acid, must fit within the chosen Connolly surface, whether it is unmodified, expanded or contracted. Accordingly, the Connolly surface is another criterion used by a search engine for evaluating or designing molecules to possess a specific predicted biological activity. The Connolly surface may be used in conjunction with the spatials for evaluating and designing molecules to possess a specific predicted biological activity.

A third criterion which may be employed in the method using and creating a search engine is a shape comprising a nucleic acid exclusion shape. This shape represents a surface which cannot be penetrated by the molecule being evaluated or designed. In other words, this parameter forms a steric constraint on the molecule being evaluated, and acts as an impenetrable border or wall. If a portion of the molecule extends into this excluded volume by penetrating the shape, then the molecule would be removed from further evaluation. When designing molecules, this shape provides a design constraint or limit since the molecule being constructed cannot penetrate this shape. In the case of one nucleic acid, DNA, a surface is created which covers the atoms facing the binding pocket in partially unwound DNA. This surface facing the binding pocket represents the van der Waals surface of the atoms facing the binding pocket in partially unwound DNA. This surface is configured and stored in the search engine. Examples of this surface are provided in FIGS. 4, 5, 8, and 9-12. The unmodified Connolly surface fits within this nucleic acid exclusion shape. Accordingly, the nucleic acid exclusion shape is another criterion used by the search engine for evaluating or designing molecules for a specific biological activity. The nucleic acid exclusion shape may be used in conjunction with the Connolly surface, with the spatial, or with both the Connolly surface and the spatial for evaluating and designing molecules to possess a specific predicted biological activity.

This method and system of the present invention can operate by accessing a database located within the search engine performing the screening or design, or by accessing a database located remotely through a network. This method and system of the present invention can operate by accessing structural and electrostatic data concerning one or more molecules, importing the data into a search engine through a network, evaluating the fit of each molecule into the spatial and optionally the Connolly surface and/or the nucleic acid exclusion shape, producing one or more results indicating predicted biological activity, and displaying or optionally transmitting the one or more results to another location. The other location may be a computer in a remote location, or other devices or systems for receiving data.

The systems and methods according to the present invention address the problems described above by providing a system, combined with access to the Internet through a network such as a local area network, to provide a prediction of the biological activity of a substance.

It is therefore an object of the present invention to provide a new method for rapidly evaluating one or more molecules and predicting one or more biological activities of the one or more molecules.

Another object of the present invention is to provide a new method for evaluating and predicting the degree of biological activity of a molecule.

It is further an object of the present invention to provide a method for rapidly evaluating and predicting one or more biological activities of one or more molecules of unknown biological activity.

Yet another object of the present invention is to provide a method for rapidly evaluating and predicting one or more biological activities of one or more molecules of suspected biological activity.

It is further an object of the present invention to provide a method for rapidly evaluating and predicting one or more biological activities of one or more molecules of suspected biological activity, wherein the biological activity is antibiotic, estrogenic, androgenic, antidepressant, sedative, anti-angiogenic, carcinogenic, glucocorticoid, or anti-impotence biological activity.

Another object of the present invention is to provide a method for rapidly evaluating and predicting one or more biological activities of one or more molecules of suspected biological activity, wherein the biological activity is anti-estrogen, osteoporosis, osteogenesis, oral antidiabetic, antipsychotic, mineralocorticoid, glucocorticoid, progestin, thyroid, retinoid, sweetener, insecticide (ecdysone), or plant hormone (gibberellic acid) biological activity.

It is further an object of the present invention to provide a method for rapidly evaluating and predicting one or more additional biological activities of one or more molecules possessing known biological activity.

Yet another object of the present invention is to provide a method for rapidly evaluating and predicting one or more biological activities of one or more molecules located in a database.

Still another object of the present invention is to provide a method for selection of molecules to test for specific biological activities.

Yet another object of the present invention is to provide a method to rapidly evaluate large numbers of molecules to determine if they are candidate molecules for possessing one or more biological activities.

Yet another object of the present invention is to provide a method to predict the degree of biological activity of molecules within a set of molecules containing the biological activity.

Still another object of the present invention is to identify molecules likely to have high, low or intermediate biological activity within a set of molecules.

Another object of the present invention is to provide a method for designing molecules to possess a desired biological activity.

Another object of the present invention is to provide a method for designing molecules to possess a desired biological activity, wherein the biological activity is antibiotic, estrogenic, carcinogenic, androgenic, antidepressant, sedative or anti-angiogenic biological activity.

Yet another object of the present invention is to provide a method for designing molecules to possess a desired biological activity, wherein the biological activity is anti-estrogen, osteoporosis, osteogenesis, oral antidiabetic, antipsychotic, mineralocorticoid, glucocorticoid, progestin, erectile, thyroid, retinoid, sweetener, insecticide (ecdysone), or plant hormone (gibberellic acid) biological activity.

Yet another object of the present invention is to decrease the costs of drug development.

A specific object of the present invention is to provide search engines for evaluating antibiotic, estrogenic, androgenic, sedative, anti-angiogenic, anti-depressant, anti-estrogenic, osteoporotic, osteogenic, oral antidiabetic, antipsychotic, mineralocorticoid, glucocorticoid, progestin, erectile, carcinogenic, thyroid, retinoid, sweetener, insecticide (ecdysone), or plant hormone (gibberellic acid) biological activities of molecules.

Yet another specific object of the present invention is to provide search engines for designing molecules to possess antibiotic, estrogenic, androgenic, sedative, anti-angiogenic, anti-depressant, anti-estrogenic, osteoporotic, osteogenic, oral antidiabetic, antipsychotic, mineralocorticoid, glucocorticoid, progestin, erectile, thyroid, retinoid, sweetener, insecticide (ecdysone), or plant hormone (gibberellic acid) biological activities.

These and other objects, features and advantages of the present invention will become apparent after a review of the following detailed description of the disclosed embodiments and claims.

### BRIEF DESCRIPTION OF THE FIGURES

FIG. 1 is a block diagram of a network including an evaluation and design system according to an embodiment of the invention.

FIG. 2 is a flow chart illustrating a method according to an embodiment of the invention for creating a search engine within the system of FIG. 1.

FIG. 3 is a flow chart illustrating a method of using a search engine.

FIG. 4. Example of the design of a compound using a search engine. Top panel: The naturally occurring biologically active estrogen, estradiol, fit within the estrogen search engine. Estradiol was one of the standards used to create the search engine. The arrows indicate portions of the molecule which could be altered to improve the volume of fit within the Connolly surface (yellow). Improved fit to the estrogen search engine is predicted to result in a candidate estrogen with improved biological potency. The nucleic acid exclusion volume is shown in magenta.

Bottom Panel: 11β-methoxy-7α-methylestradiol (also called PDC-7 herein) is an example of a molecule which is an analog of estradiol and has suitable substitutions (arrows; cf top panel) that improve volume fit to the Connolly surface (yellow) of the estrogen search engine. PDC-7 was not used in the creation of the estrogen search engine but hits the estrogen search engine. PDC-7 has improved biological potency over estradiol in uterotrophic assays as predicted by better fit.

FIG. 5. Top Left: Skeletal models of biologically active estrogens (standards) docked into partially unwound DNA.

Middle Left: Skeletal model of partially unwound DNA and electrostatic spatials derived from the positions of hydrogen bonds between heteroatoms on the DNA and biologically active estrogens

Bottom Left: Skeletal model of PDC-7, a compound not used to create the search engine but which hit the spatials

Top Right: Space filling models of biologically active estrogens (standards) docked into partially unwound DNA (view with skeletal models shown Top Left).

Middle Right: Nucleic acid exclusion volume of search engine shown in magenta which was derived from the surface of the unwound DNA; Connolly surface resulting from the composite sum of biologically active estrogens (standards) docked into partially unwound DNA (see Top Right); 1.5 angstrom core (yellow) surrounding the Connolly surface (green)

Bottom Right: Space filling model of PDC-7, which hits all the criteria of the estrogen search engine, shown in the orientation identified by the search; the view of the search engine is partially clipped in the plane of the figure to show the fit of PDC-7. PDC-7 has been synthesized and shown to possess potent estrogenic activity.

FIG. 6. Spatials shown as clouds (gray-white) of different search engines representing electrostatic points in space and skeletal models of partially unwound DNA from which the spatials were derived. The spatials differ in position, shape and size and reflect appropriate hydrogen bonds permitting the fit of candidate molecules into the DNA sites. The spatials are components of search engines employed in the searches of three dimensional databases. A) antidepressant search engine spatials; B) sedative search engine spatials; C) androgen search engine spatials; D) estrogen search engine spatials.

FIG. 7. Nucleic acid excluded volumes (magenta) derived from the van der Waals surfaces of the unwound sites in DNA used in various search engines. The nucleic excluded volumes represent places in three dimensional space into which a candidate molecule may not fit. The excluded volumes are used in conjunction with the electrostatic spatials to search three dimensional databases. A) antidepressant search engine excluded volume; B) sedative search engine excluded volume; C) androgen search engine excluded volume; D) estrogen search engine excluded volume.

FIG. 8. Connolly surfaces (yellow-green) are a component of search engines derived from the aggregate van der Waals surfaces of candidate molecules fit into specific sites in DNA; the surfaces were expanded (see values in Table 1). The Connolly surfaces can be used to search various three dimensional databases or used in conjunction with spatials and/or nucleic acid excluded volumes to search such databases. A) antidepressant search engine Connolly surface; B) sedative search engine Connolly surface; C) androgen search engine Connolly surface; D) estrogen search engine Connolly surface.

FIG. 9. Combined spatials (gray-white), excluded volumes (magenta) and Connolly surfaces (yellow-green) for: A) the antidepressant search engine; B) the sedative search engine; C) the androgen search engine; D) the estrogen search engine.

FIG. 10. Antibiotic (cipro) search engine: A) Skeletal models of ciprofloxacin and other standards (Table 1) used in the formation of the antibiotic (cipro) search engine (standards) docked into partially unwound DNA; B) Space filling models of ciprofloxacin and the other standards docked into partially unwound DNA; C) Spatials (gray-white) for the antibiotic (cipro) search engine shown in relationship to partially unwound DNA; D) Nucleic acid exclusion volume of search engine shown in magenta which was derived from the surface of the unwound DNA; E) Connolly surface (dark green) plus 2 angstroms (light yellow-green) resulting from the composite sum of ciprofloxacin and other standards; F) Antibiotic (cipro) search engine showing information from C, D, and E.

FIG. 11. A) Antibiotic (cipro) search engine spatials; B) Nucleic acid exclusion volume of search engine shown in magenta which was derived from the surface of the unwound DNA; C) Connolly surface plus 2 angstroms (light yellow-green) resulting from the composite sum of ciprofloxacin and other standards; D) Antibiotic (cipro) search engine showing information from A, B, and C.

FIG. 12. Both columns show, from top to bottom, the antibiotic (cipro) search engine spatials, nucleic acid exclusion volume, Connolly surface plus 2 angstroms, and the combined antibiotic (cipro) search engine showing the spatials, nucleic acid exclusion volume and Connolly surface plus 2 angstroms. The left column shows ciprofloxacin in skeletal form (top) and in space filling form (bottom 3 figures in the column). The right column shows ampicillin in skeletal form (top) and in space filling form (bottom 3 figures in the column.)

FIG. 13. Structures of the standards used to make the antibiotic (cipro) search engine and ampicillin, identified by the antibiotic (cipro) search engine.

FIG. 14. Average in vivo estrogenic activity of hits versus the number of steps using the estrogenic search engine. The y axis indicates the average estrogenic biological activity of molecules (hits) identified by the estrogen search engine divided by the number of molecules (hits) identified by the estrogenic search engine. The x-axis demonstrates the number of steps using the search engine.

FIG. 15. Demonstration of the enrichment rate (y-axis-total number of structures divided by the number of molecules (hits) containing biologically active estrogenic molecules) using the estrogen search engine, as a function of the number of steps used in searching with the estrogen search engine. The optimal parameters included a 0.35 angstrom included volume which was associated with an enrichment rate greater than 40 fold (32 hits of 1470 stereochemically accurate structures whose biological activities were reported by the National Institutes of Health).

FIG. 16 is an exemplary interface to an estrogen search engine showing selection of a database and search query.

### DETAILED DESCRIPTION OF THE INVENTION

The present invention provides new computer-based systems and methods for rapid evaluation of molecules in order to identify molecules suspected of possessing one or more specific biological activities. The systems can also identify the degree of biological activity or relative potency of molecules. The systems have search engines that may be used to access databases containing numerous molecules and to rapidly evaluate these molecules in order to predict biological activity. In another embodiment, the present invention provides new computer-based systems and methods for rapid design of molecules with a high likelihood of possessing a desired biological activity.

Description of a Network Having an Evaluation and Design System

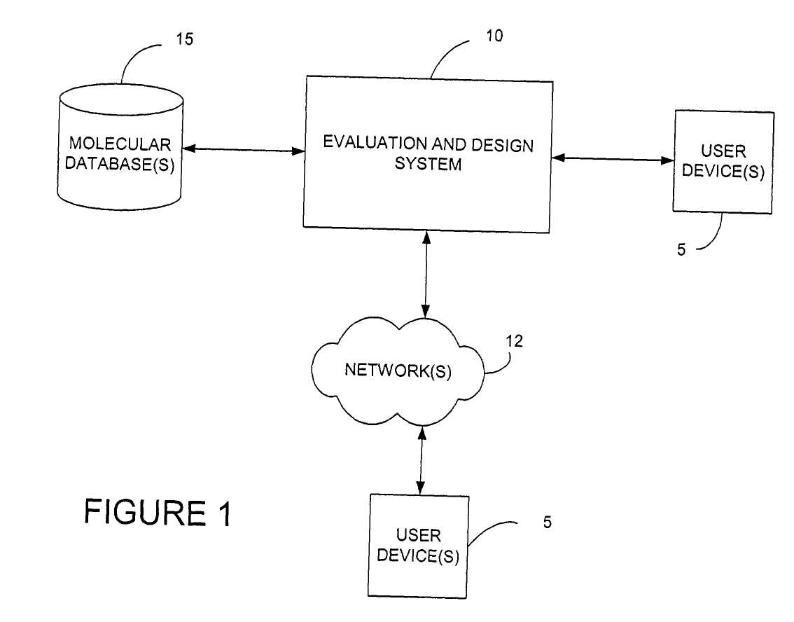

An Evaluation and Design system 10 (“system”) 10 according to a preferred embodiment of the invention is illustrated in FIG. 1. The system 10 receives information from one or more databases 15. These databases 15 may be derived from one or more sources, such as but not limited to governmental sources, commercial suppliers, universities, internal database, or any other public or private source of data. Some examples of databases 15 include SIGMA, ALDRICH, Phoenix, Maybridge, Molecular Probes, Calbiochem, Chemnavigator, and Molecular Design Limited (MDL). In the examples given above, the databases 15 reside and are managed at another location. Alternatively, the databases 15 may be imported into the system 10 or built and stored on location by the system 10 for analysis using the system 10.

The system 10 communicates and interfaces with a plurality of devices 5 either directly or through one or more networks 12. The system 10 is not limited to any particular type or model of user device 5. Thus, the user device 5 can be any type of data or communication device, such as but not limited to computers, mobile radiotelephones, lap-top computers, digital TV, WebTV, and other TV products, Palm Pilots, Pocket PCs, and other Personal Digital Assistants. The system 10 advantageously is not limited to these types of user devices 5 but is able to accommodate new products as well as new brands, models, standards or variations of existing products. The system 10 can optimize the presentation and selection of information according to the network 12 as well as the user device 5.

The network 12 will, of course, vary with the user device 5 receiving the information from the system 10. For mobile radiotelephones, the network may comprise AMPS, PCS, GSM, NAMPS, USDC, CDPD, IS-95, GSC, Pocsag, FLEX, DCS-1900, PACS, MIRS, e-TACS, NMT, C-450, ERMES, CD2, DECT, DCS-1800, JTACS, PDC, NTT, NTACS, NEC, PHS, or satellite systems. For a lap-top computer, the network 12 may comprise a cellular digital packet data (CDPD) network, any other packet digital or analog network, circuit-switched digital or analog data networks, wireless ATM or frame relay networks, EDGE, CDMAONE, or generalized packet radio service (GPRS) network. For a TV user device 5, the network 12 may include the Internet, coaxial cable networks, hybrid fiber coaxial cable systems, fiber distribution networks, satellite systems, terrestrial over-the-air broadcasting networks, wireless networks, or infrared networks. The same type of networks 12 that deliver information to mobile radiotelephones and to lap-top computers as well as to other wireless devices, may also deliver information to the PDAs. Similarly, the same types of networks 12 that deliver information to TV products may also deliver information to desk-top computers. It should be understood that the types of networks 12 mentioned above with respect to the user devices are just examples and that other existing as well as future-developed networks may be employed and are encompassed by the invention.

As should be apparent from the description above, the network 12 may comprise a Local Area Network (“LAN”), a Wide Area Network (“WAN”), a peer-to-peer network, an Application Service Provider (“ASP”), a Virtual Private Network (“VPN”), or the Internet. For instance, in one embodiment, the evaluation and design system 10 may be used on line through the Internet to access large molecular databases to evaluate these molecules for predicted biological activity. In one embodiment, this system 10 may be used on-line through a LAN to access large molecular databases to evaluate these molecules for predicted biological activity.

In addition to communicating with the system 10 through a network 12, the user device 5 may also interface directly with the system 10. The system 10 can be resident on the user device 5, such as in a stand-alone installment of the system 10 on a computer.

Various business models may be formed around the systems and methods according to the invention. For example, the evaluation and design system 10 may be licensed and installed within an organization, such as a pharmaceutical company for performing the evaluation and design of molecules. As another example, an entity may use the system 10 to perform the design and/or evaluation of molecules on a fee basis for a pharmaceutical company. Instead of a license, users may be charged a fee for accessing the evaluation and design system 10, such as through an ASP. Software incorporation functionality within the system 10 may be bundled with other software, such as with searching tools associated with the databases 15 or with other evaluation and/or design software. Other examples will be apparent to those skilled in the art upon reading this application.

Definitions

The term “biological activity” is used herein to indicate activity in any biological system. Accordingly, biological activity may occur in vitro or in vivo. Biological activity may occur in or on cells, in tissues, organs, and systems. Biological activity may also occur in cell free systems, using extracts, membrane preparations, or preparations of biological extracts, including but not limited to extracts containing any biological molecule. Some of the biological activities identified with the search engines in the present application include but are not limited to estrogenic, androgenic, sedative, anti-depressant, anti-angiogenic, antibiotic, anti-impotence, carcinogenic, and glucocorticoid biological activities. Additional biological activities identified with the search engines of the present invention include anti-estrogen, osteoporosis, osteogenesis, oral antidiabetic, antipsychotic, mineralocorticoid, progestin, thyroid, retinoid, sweetener, insecticide (ecdysone), and plant hormone (gibberellic acid) biological activities.

The term “drug design” signifies a method of identifying or constructing the structures of biologically active molecules. The term “screening” refers to a method of identifying or predicting potentially biologically active molecules. Some of these molecules can be used to make therapeutics. In this sense, screening can refer to a method of drug design in which molecules are selected from a database of existing chemical structures. Screening chemical databases is one method employed in drug design.

Description of the Method of Creating the Search Engines: the Spatials, Docking, Developing the Connolly Surface and the DNA Excluded Volume

Systems and methods according to the present invention facilitate rapid evaluation of molecules in order to provide molecules suspected of possessing a specific biological activity and their relative biological activity or potency. For the purposes of this description, a search engine is an instance of the system 10 which is configured for a specific binding site based on knowledge of molecules with known biological activity. For instance, one search engine may be configured for estrogen while another search engine may be configured for androgen. The system 10 therefore encompasses at least one search engine and may comprise a plurality of such search engines.

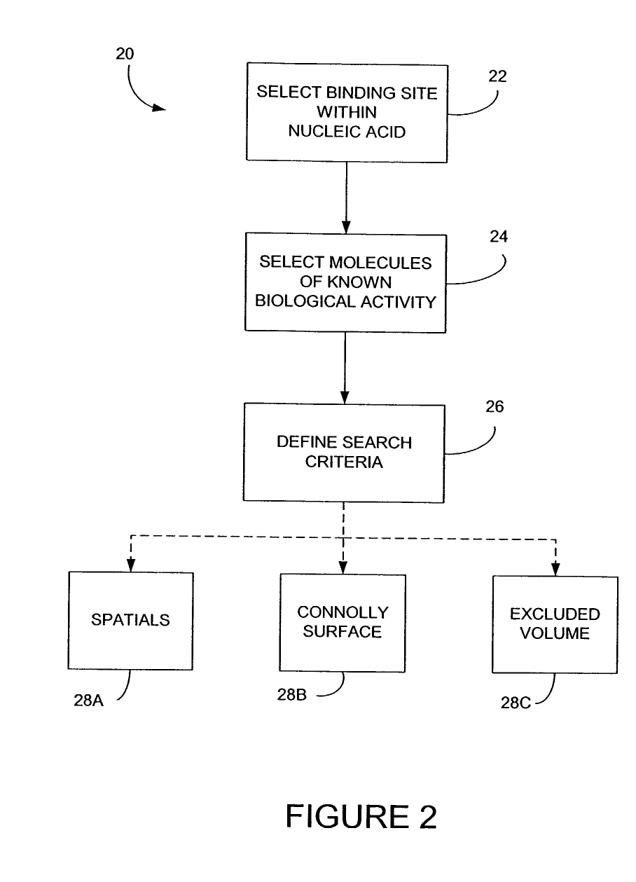

In general, a method 20 according to one embodiment of the invention for creating a search engine will now be described with reference to FIG. 2. At 22, the method 20 involves selecting a binding site within nucleic acid and at 24 choosing one or more molecules of known biological activity. Next, at 26, search criteria are defined for the binding site and for the known molecules. The search criteria may comprise defining spatials at 28A, an included volume such as through Connolly surfaces at 28B, and/or excluded volumes at 28C. As discussed in more detail below, the search criteria preferably include more than one of the spatials 28A, included volume 28B, and Connolly surface 28C.

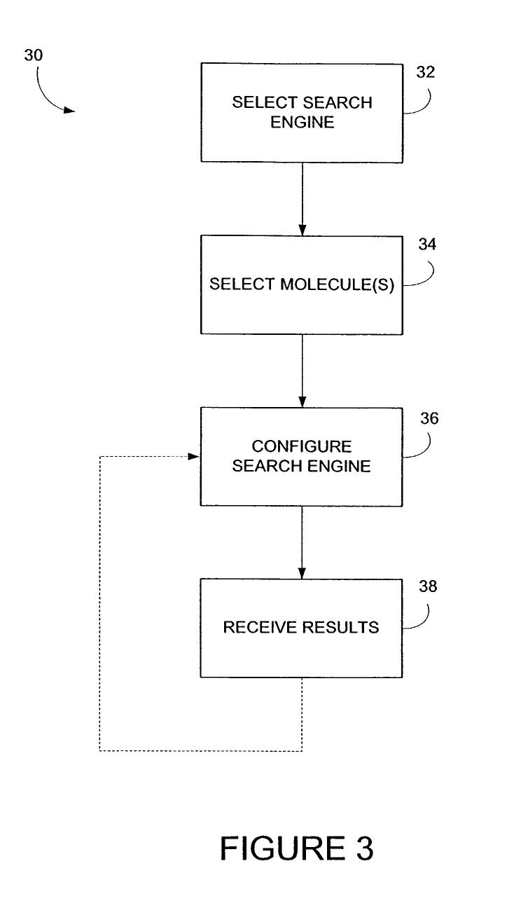

After a search engine is created through method 20, then the search engine is used to evaluate molecules of unknown biological activity. FIG. 3 is a flow chart illustrating an overall method 30 of using a search engine. The method 30 begins at 32 with selecting the search engine. For instance, if one is interested in evaluating the estrogenic biological activity, then the estrogenic search engine would be selected at 32. The method 30 includes selecting the molecule or molecules to be evaluated at 34, such as by selecting a file containing information on a molecule or a database of information on a plurality of molecules. The search engine is then configured at 36 to select one or more of the search criteria. The results are then provided to the user at 38.

As represented by dashed lines, the use of the search engine may be an iterative process in which the user selects one set of search criteria, receives a list of potential molecules, and then selects another set of search criteria. This iterative process may involve first selecting one of spatials 28A, included volume 28B, and excluded volume 28C and then, after receiving the results, selecting another of the spatials 28A, included volume 28B, and excluded volume 28C. Alternatively, or in addition, the iterative process may involve progressively setting tighter tolerances to reduce the number of potential molecules.

Formation of Spatials

The method 20 of creating a search engine includes defining spatials at 28A. More specifically, defining spatials at 28A involves docking the one or molecules of known biological activity into nucleic acids. Docking is accomplished by evaluating both electrostatic interactions of the molecule and the nucleic acid and also the physical interaction of the one or more molecules with the site on the nucleic acid into which they will fit. Electrostatic interactions are evaluated by choosing heteroatoms on the one or more molecules of known biological activity and heteroatoms on the nucleic acid which possess favorable electrostatic properties for establishing hydrogen bonds. These locations and charge characteristics are configured into the search engine.

These heteroatoms on the molecule(s) or the nucleic acid are operationally called donor atoms or acceptor atoms. For simplicity, the following description defines the heteroatoms on the molecule as donor atoms and the heteroatoms on the nucleic acid as acceptor atoms. It is to be understood however that heteroatoms on the molecule may be acceptor atoms and the heteroatoms on the nucleic acid may act as donor atoms. Acceptor atoms are defined as heteroatoms that are capable of serving as a hydrogen bond acceptor; donor atoms are defined as heteroatoms that can serve as hydrogen bond donor.

Next, the electrostatic field and directionality are determined by docking the donor atoms and acceptor atoms. The docking procedure reveals: 1) a range of acceptable distances for electrostatic interaction of the donor atoms and the acceptor atoms—as an ideal hydrogen bond length is approached, the electrostatic interaction increases; and, 2) a direction and range of orientations for electrostatic interaction of the donor atoms and the acceptor atoms. These parameters, revealed through the docking procedure, define three dimensional shapes with associated tolerances. These three dimensional shapes define chemical parameters including a suitable range of electrostatic interactions and hydrogen bond distances. The range of orientations for electrostatic interaction of the donor atoms and the acceptor atoms is determined by examining the hydrogen bonding functional groups on both the nucleic acid and docked molecule including any rotatable bonds, e.g., a hydroxyl group rotatable bond of the heteroatoms on the nucleic acid.

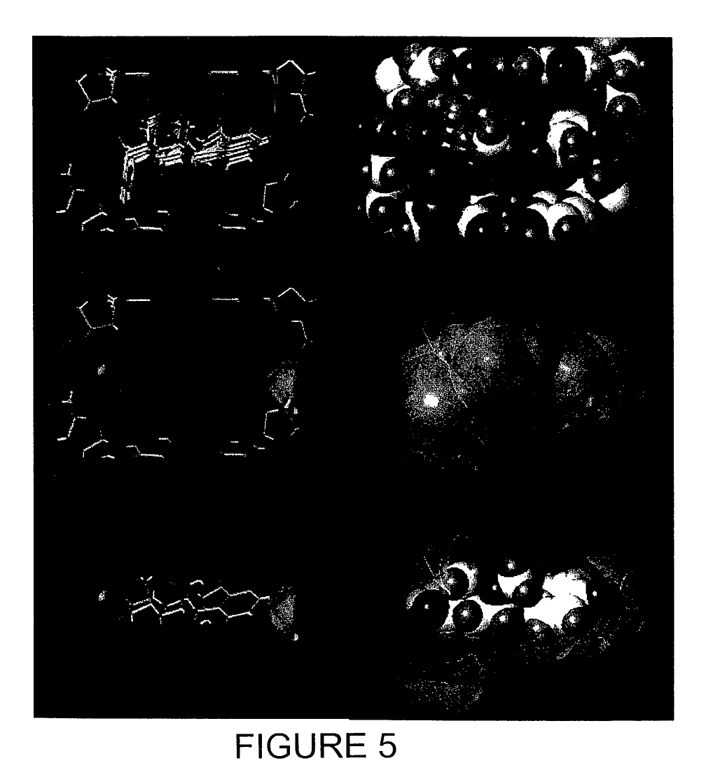

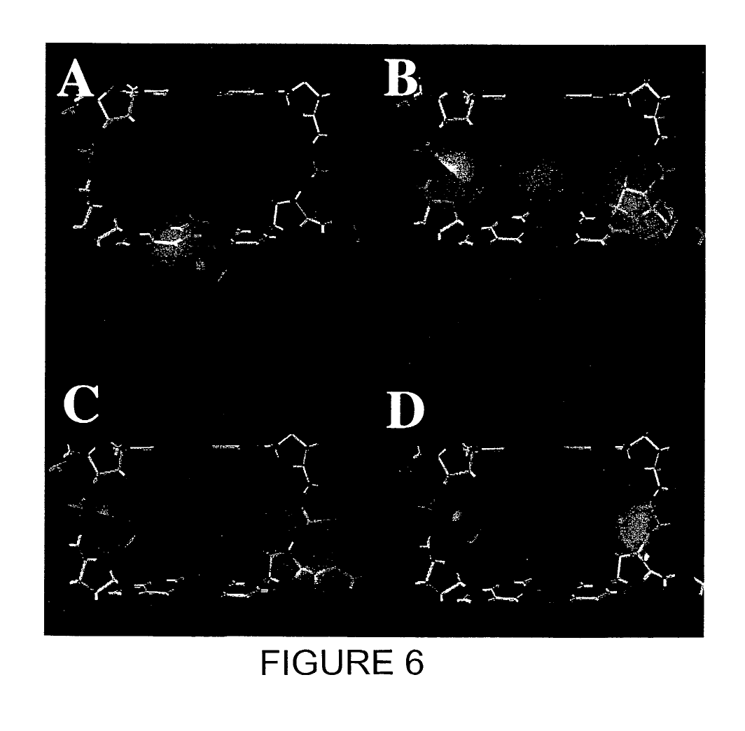

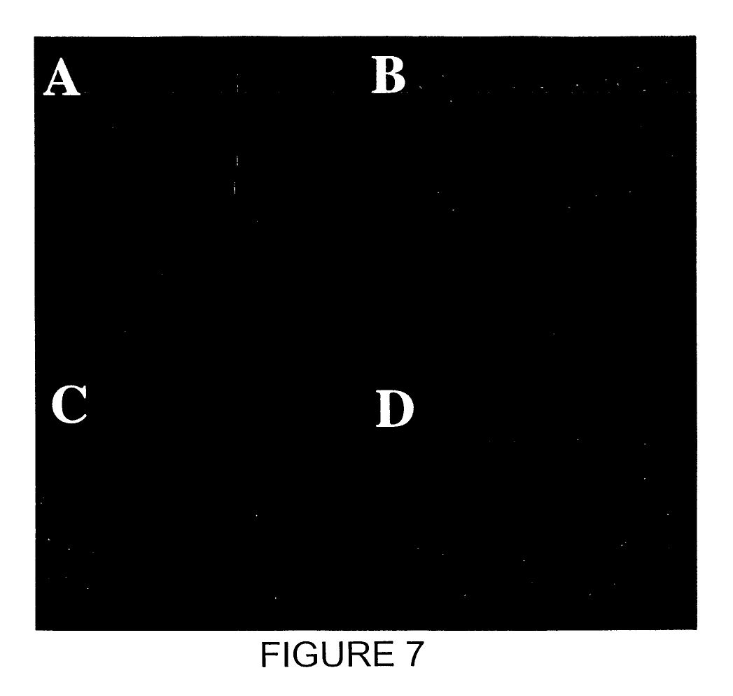

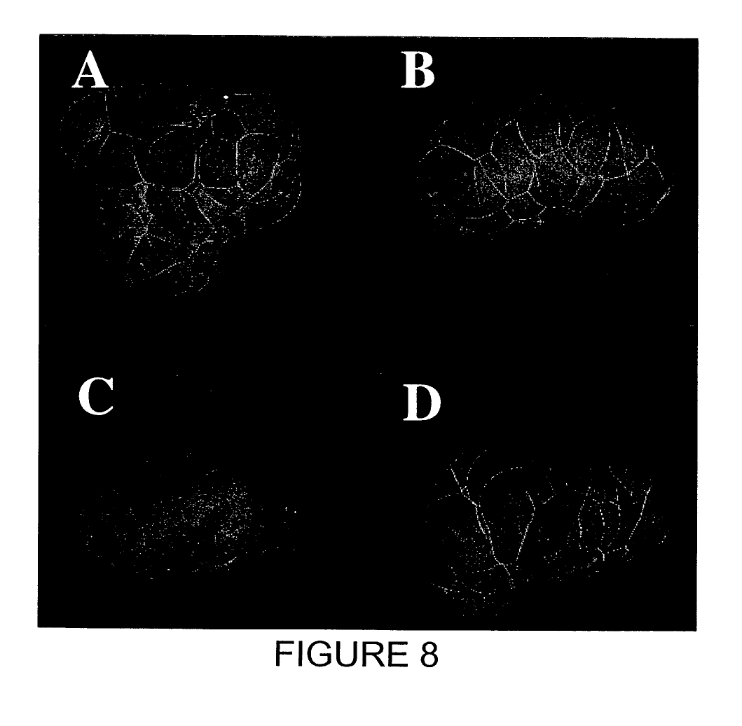

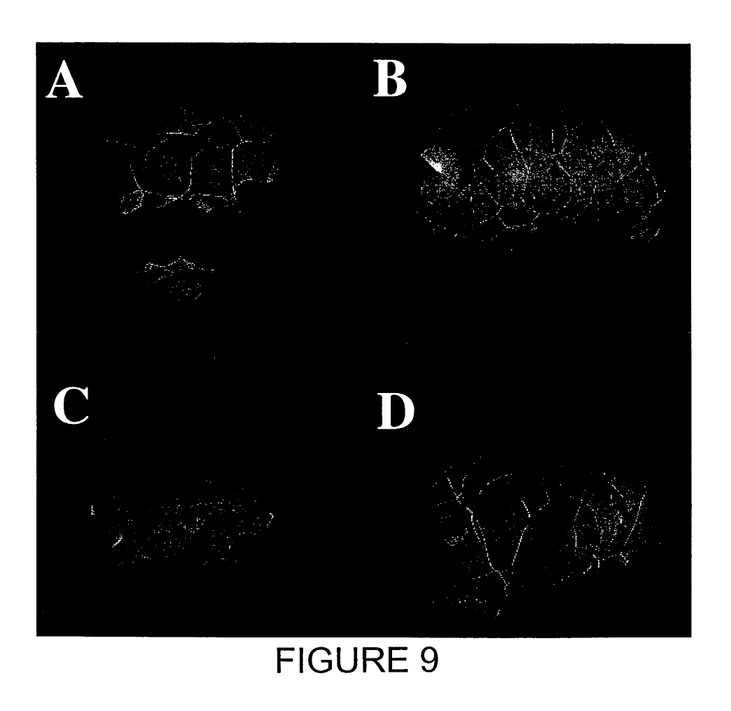

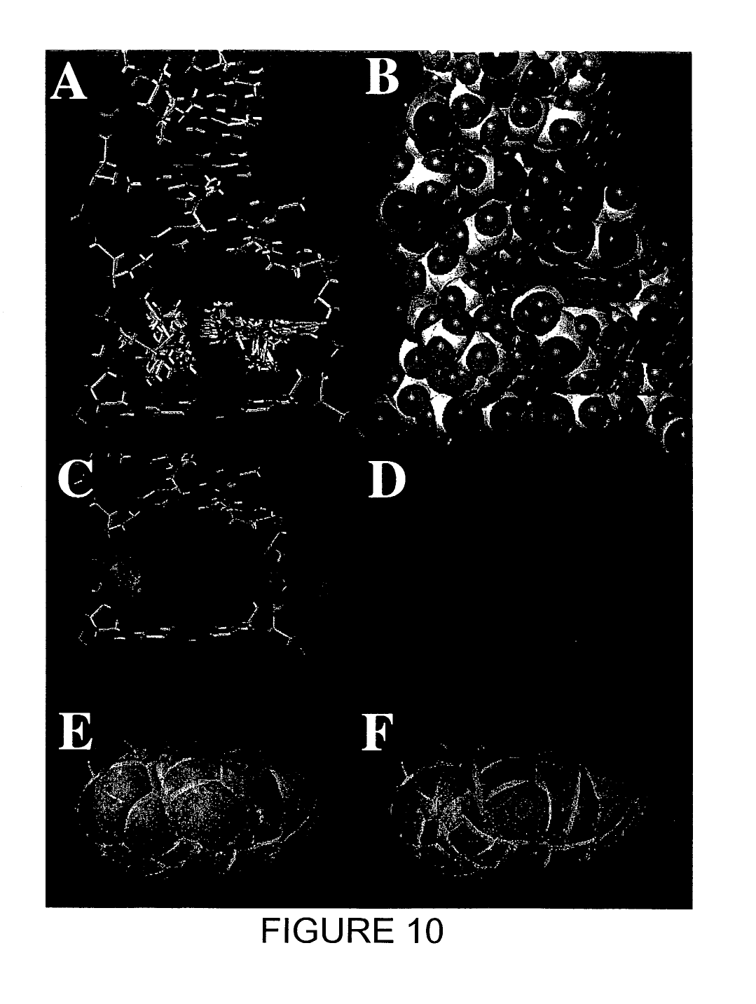

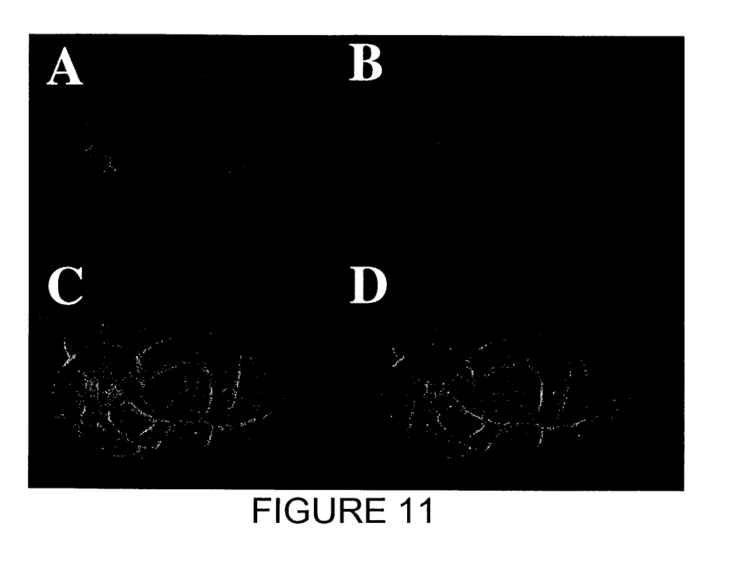

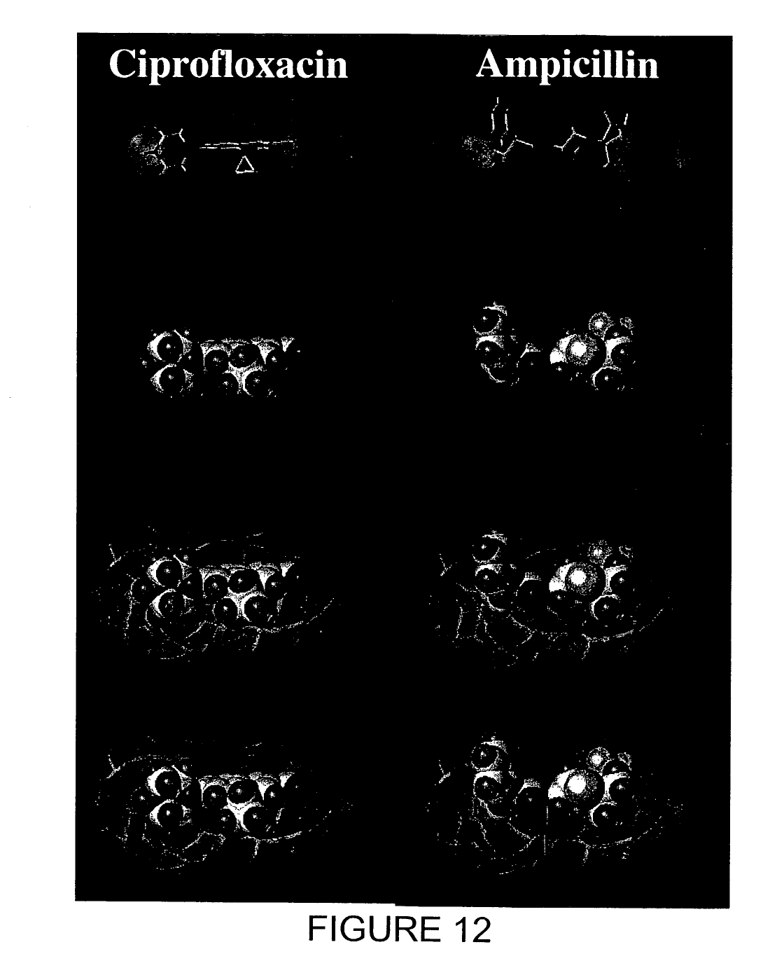

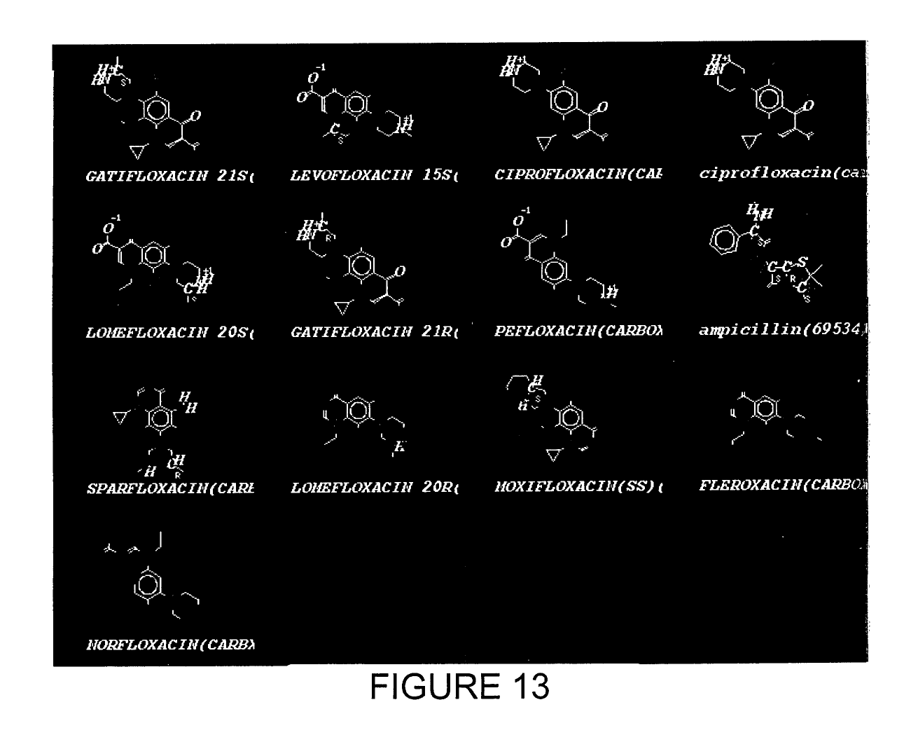

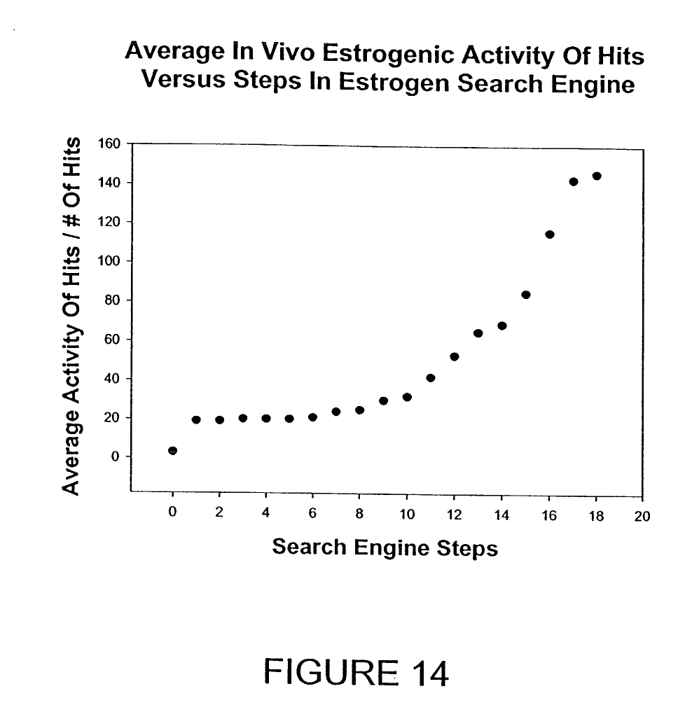

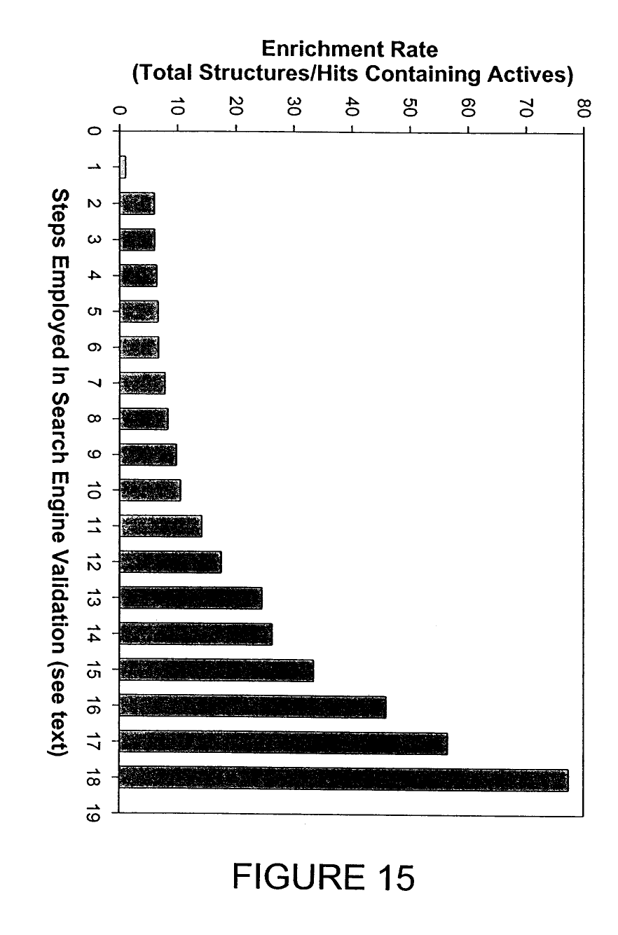

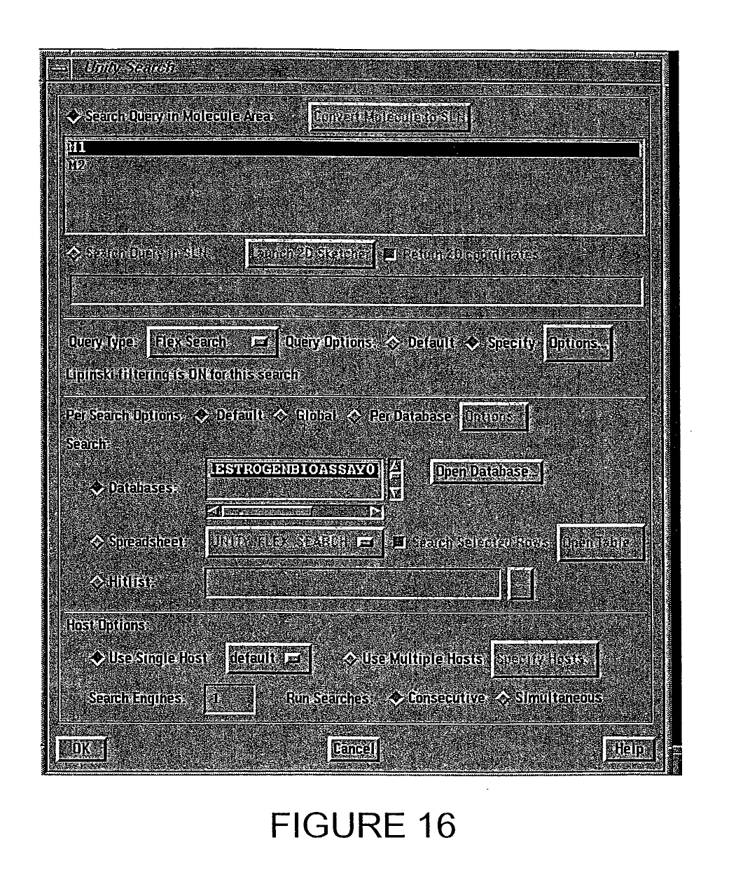

These three dimensional shapes define a volume in which either a donor or acceptor atom on a given ligand may form a hydrogen bond with an acceptor or donor atom on the nucleic acid. In the context of the present invention, these three dimensional shapes are called spatials. Examples of spatials are shown in FIGS. 5, 6, 10, 11, and 12.

The number of these spatials varies depending on the number of binding points on the acceptor or donor heteroatoms. Such binding points are called electrostatic points in the present invention. Accordingly a ligand with an acceptor heteroatom and a nucleotide in a nucleic acid binding pocket with a donor heteroatom will have at least one electrostatic point and associated spatial. This spatial is a three dimensional representation of the volume in which the donor or acceptor heteroatom may form hydrogen bonds. In a sense, the spatials emanate from the electrostatic points. It is to be understood that specific classes of molecules may have different numbers of electrostatic points or spatials when interacting with a nucleic acid, such as DNA. In the present invention, estrogenic molecules have 2 spatials, sedative molecules have 3 spatials, androgenic molecules have 2 spatials, and antidepressant molecules have 1 spatial (FIG. 6). In the present invention, antibiotic molecules have 2 spatials (FIG. 11).

One or more molecules of known biological activity are used to construct the one or more spatials that represent the donor-acceptor interactions between the acceptor atom on the nucleic acid and the donor atoms on the one or more molecules of known biological activity. It is to be understood that the molecule or the nucleic acid can be either a donor or acceptor. The one or more spatials represent the geometrical constraints for evaluating molecules and identifying them as likely candidates for a specific biological activity. For example, in the case of estrogenic molecules and DNA, once the spatials are constructed for estrogenic activity, and configured in the search engine, then the molecule of unknown or suspected biological activity is evaluated to determine whether its donor heteroatoms (in this case the estrogens are donors) or acceptor heteroatoms atoms fit into these spatials.

The spatial includes bond lengths between acceptor and donor heteroatoms that are favorable for forming a hydrogen bond. Therefore, the spatial does not include the entire physical distance between the acceptor and donor heteroatom, only that portion of the distance favorable for forming a hydrogen bond.

These spatials are different from the pharmacophores previously described in U.S. Pat. Nos. 5,705,335, 5,888,738, 5,888,741, and 6,306,595. Those pharmacophores represented a three dimensional shape, comprised of electrostatic points in space with associated charges, of the aggregate average shape of selected molecules of known biological activity when docked appropriately into nucleic acids. In contrast, the spatials of the present invention represent a three dimensional volume of interaction between the acceptor or donor heteroatom on the nucleic acid and the donor or acceptor heteroatom on the one or more molecules of known biological activity. The spatials may be used alone, or as a component in a process for evaluating whether a molecule possesses the donor or acceptor heteroatoms and correct stereochemistry to fit within the spatials.

When one or more spatials are used for evaluating molecules, there is a three dimensional requirement that the molecule's acceptor or donor heteroatom must fit within the spatial. The resulting spatials reflect normal ranges of acceptable hydrogen bond distances and locations in three dimensional space. During the search process, with a search engine, depending upon whether a spatial is defined as a heteroatom donor or acceptor, the functional groups on the searched molecules must fit within these criteria.

If the search engine determines that a molecule of unknown biological activity fits the one or more spatials associated with heteroatoms of molecules of known biological activity and the heteroatoms on the nucleic acid, then the search engine identifies it as having a likelihood of possessing the biological activity. If the search engine finds that this molecule also fits within the Connolly surface described in the next paragraph, then the molecule would possess a higher likelihood of possessing that biological activity. The search engine stores this data concerning this identification as fitting within the spatial in an appropriate location, such as in a list of molecules having a likelihood of possessing the biological activity. Such activity may be evaluated using tests known to one of ordinary skill in the art. The search engine places this molecule in a list indicating that it is predicted to have the biological activity.

Next, the search engine selects the second molecule to be evaluated and determines the fit of this second molecule to the spatial. The search engine stores the results of this evaluation in the appropriate location, such as in the list and are optionally displayed through a display. This process continues for all molecules being evaluated, such as all molecules within a database.

Connolly Surface

A Connolly surface defined at 28B provides another tool for use in the present invention for rapidly evaluating molecules of unknown biological activity or designing molecules to possess a specific biological activity. As stated above, one or more molecules of known biological activity are selected and are fit sterically and electrostatically into a nucleic acid binding site. A Connolly surface is defined as the composite shape of the surfaces of all of the selected biologically active molecules which fit within the nucleic acid binding site. The Connolly surface represents the greatest upper bound of the shapes of all the selected molecules. For example, if four molecules of known biological activity were selected, as in the sedative pharmacophore of the present application, docked into DNA and the spatials created, then the surface aggregate shape of these four molecules is defined as the Connolly surface. The Connolly surface has no charge and is a hard surface or border which cannot be penetrated.

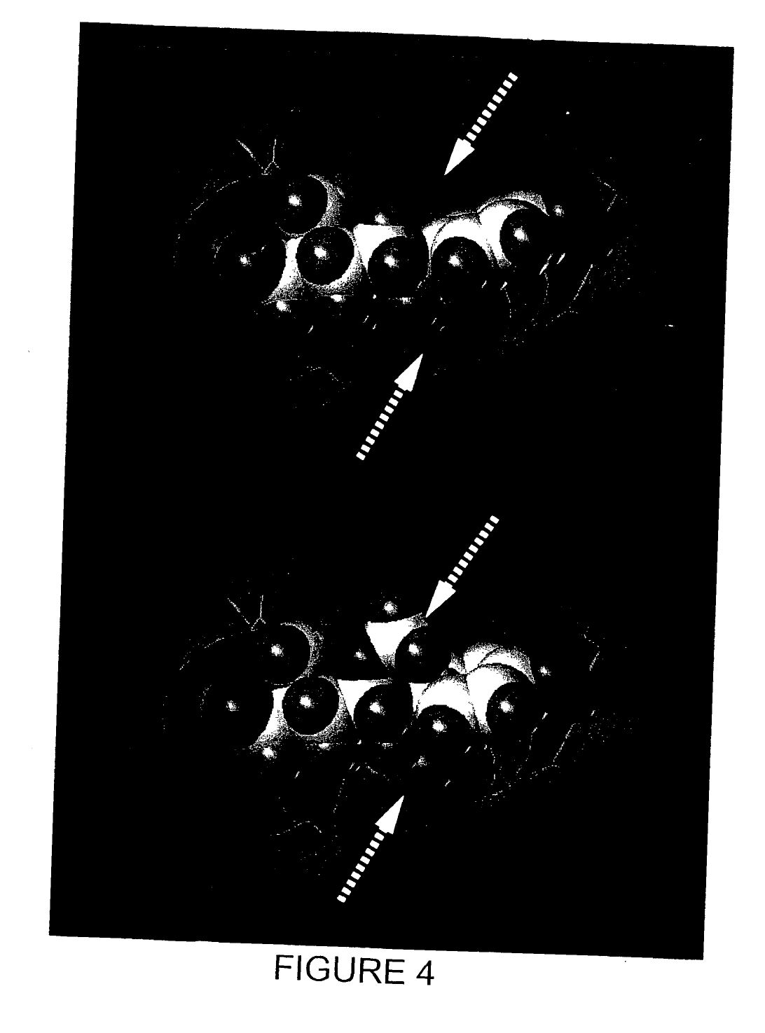

The Connolly surface is created and configured within the search engine. The Connolly surface may be defined in ways known to one of ordinary skill in the art using features of Sybyl® software sold by Tripos of St. Louis Mo. A probe atom, represented as a sphere, is rolled over the accessible surface of the aggregate shape of the surfaces of all of the selected active molecules which fit within the nucleic acid. This process smoothes over the invaginations or crevices of the aggregate shape and creates a solid surface which is stored in the search engine. Examples of a Connolly surface are provided in FIGS. 4, 5, 8 and 9.

A Connolly surface may be expanded to encompass a greater volume. In the present invention, the tolerance feature of the Sybyl® software is used to add distance to the Connolly surface. Different distances may be added, including but not limited to sub-angstrom, angstrom, or multiples of angstroms. Preferred distances for addition to a Connolly surface are between about 0.01 to about 10 angstroms, with a more preferred range of from about 0.05 to about 7 angstroms, with a most preferred range of from about 0.1 to about 3 angstroms.

Modifying the Connolly surface through addition is used to perform a broader search than would be obtained using the non-expanded Connolly surface. In other words, an expanded Connolly surface would permit a greater number of molecules to fit within it, as compared to a non-expanded Connolly surface. At the initial stages of a search of several molecules of unknown activity, such as a database search, an expanded Connolly surface, for example the Connolly surface plus 3 angstroms, would eliminate fewer molecules since more molecules would fit within this greater volume. Such expanded Connolly surfaces are especially useful in initial stages of searches. After identification of molecules that fit within this expanded Connolly surface, a second search with a less expanded surface, for example 2.5 angstroms, would eliminate some of the compounds captured initially. By successively reducing the degree of expansion of the surface, one approaches the non-expanded Connolly surface as a limit. As demonstrated in the Examples, application of successive steps in a search engine, for example, successively reducing the expanded Connolly surface may be correlated with increased biological activity. It is believed that molecules associated with a specific step, for example those molecules identified by the reduction in the included volume from one angstrom distance to another angstrom distance, are likely to possess a specific range of biological activity and may be useful for achieving a desired therapeutic efficacy.

In another embodiment of the present invention, a Connolly surface may be reduced by subtracting distance from the Connolly surface. Different distances may be subtracted, including but not limited to sub-angstrom, angstrom, or multiples of angstroms. Preferred distances for subtraction to a Connolly surface are between about 0.01 to about 2 angstroms, with a more preferred range of from about 0.05 to about 1 angstroms, with a most preferred range of from about 0.1 to about 0.5 angstroms. For example, if 0.3 angstroms were subtracted from a Connolly surface, molecules that would identified in the search as fitting within this reduced Connolly surface would be predicted to have lower biological activity relative to compounds that would be included in the non-modified Connolly surface. Use of this reduced Connolly surface encompassing a lower volume provides a way of excluding some molecules that would fit within the non-modified Connolly surface but would not be expected to be biologically active because they would be too small. Such small molecules would be unlikely to interact with the DNA site.

Boolean subtraction may be employed to remove molecules which fit within small or reduced Connolly surfaces from those fitting within the larger Connolly surfaces. This eliminates molecules too small to be considered further. This approach may be employed as a method of further refining the molecules identified with the present method.

If the molecule of unknown biological activity fits within the Connolly surface, then the search engine identifies it as having a likelihood of possessing the biological activity. If this molecule also fits within the spatial described in the preceding section, then the molecule would possess a higher likelihood of possessing that biological activity. The search engine stores data concerning this identification as fitting within the Connolly surface in an appropriate location, such as in a list of molecules having a likelihood of possessing the biological activity. Such activity may be evaluated using tests known to one of ordinary skill in the art. This molecule is then placed in a list indicating that it is predicted to have the biological activity.

Next, the search engine selects the second molecule to be evaluated and determines the fit of this second molecule to the Connolly surface. The search engine stores the results of this evaluation in the appropriate location, such as in a list and are optionally displayed through a display. This process continues for all molecules being evaluated, such as all molecules within a database.

Nucleic Acid Exclusion Volume Shape

Another parameter, or criterion, used in the present invention for evaluating molecules of unknown biological activity or designing molecules for possessing a desired biological activity is the excluded volume at 28C. The excluded volume is a surface which cannot be penetrated by the molecule being evaluated or designed. In other words, this parameter forms a steric constraint on the molecule being evaluated, and acts as an impenetrable border or wall. If a portion of the molecule extends into this excluded volume by penetrating the shape, then the molecule would be removed from further evaluation. When designing molecules, this shape provides a design constraint or limit since the molecule being constructed cannot penetrate this shape.

In the case of one nucleic acid, DNA, a surface is created which lines the atoms facing the binding pocket in partially unwound DNA. This surface facing the binding pocket represents the van der Waals surface of the DNA. This surface is configured in the search engine at 28C. Examples of this surface are provided in FIGS. 4, 5, 7 and 8. The unmodified Connolly surface fits within this nucleic acid exclusion shape (FIGS. 5 and 10). In cases where a given hydrogen bond results in a compressed van der Waals surface, the participating heteroatoms on the nucleic acid are removed prior to constructing the exclusion shape.

If the molecule of unknown biological activity fits within the nucleic acid exclusion shape and also fits within the spatial or the Connolly surface as described above, then the search engine identifies it as having a likelihood of possessing the biological activity. If this molecule fits within the nucleic acid exclusion shape, the spatial and the Connolly surface described in preceding sections, then the molecule would possess a very high likelihood of possessing that biological activity.

The search engine stores data concerning this identification as fitting within the nucleic acid exclusion shape in an appropriate location, such as in a list of molecules having a likelihood of possessing the biological activity. Such activity may be evaluated using tests known to one of ordinary skill in the art. The search engine then places this molecule in a list indicating that it is predicted to have the biological activity.

Next, the search engine selects the second molecule to be evaluated and determines the fit of this second molecule to the nucleic acid exclusion shape. The search engine stores the results of this evaluation in the appropriate location, such as in a list and are optionally displayed through a display. This process continues for all molecules being evaluated, such as all molecules within a database. At any time, data concerning how an individual molecule fits within the different aspects of the search engines (the spatial, Connolly surface or nucleic acid volume exclusion shape) may be accessed, displayed and optionally analyzed for the extent to which it fits these different aspects of the search engines. This analysis is primarily qualitative and can involve considerations such as the reasonableness of the hydrogen bond length, whether the molecule contacts the nucleic acid exclusion shape, and whether the molecule extends beyond a Connolly surface but is contained within the expanded Connolly surface.

Conformation

For each molecule being evaluated for a suspected biological activity, the search engine rotates the rotatable bonds within the molecule and attempts to fit each conformation into the search parameters comprising spatials, the Connolly surface, and the nucleic acid exclusion volume shape. Molecules, and their conformations that fit the search criteria, are stored by the search engine and optionally displayed through a display, such as a monitor, or output such as to a printer. Since some molecules possess numerous rotatable bonds and would require extensive computing time to examine all conformations, the operator may configure the search engine by selecting the number of conformations to be evaluated using the “number of conformations” feature of the Sybyl® program. Once the number of conformations is selected, and the selection may be random, then the search engine will successively place the molecule in the selected number of conformations prior to evaluating each specific molecular conformation for degree of fit into the search criteria. A subprogram of Sybyl®, called Confort®, which automatically creates acceptable low energy conformations may also be employed with the search engine according to an embodiment of the present invention.

Search Criteria:

Spatials, the Connolly Surface, Nucleic Acid Exclusion Volume Shape, Duration of Search, Partial Match Constraints and Number of Conformations

Several parameters may be modified at 36 using the method of the present invention in order to affect the search and evaluation process. Such modifications may influence the total duration of the evaluation of each molecule, the number of different molecular conformations to be evaluated, and the number of matches to the spatials surrounding each electrostatic point in a given search engine. By modifying these parameters, the total search duration for a given database may be lengthened or shortened. Further, the thoroughness of a search may be affected, for example by evaluating only 2 or 4 conformations of a molecule instead of all possible conformations. In some cases, a searcher may desire a rapid search of a large database to narrow down the number of molecules. This is facilitated by modifying the search criteria, for example, by decreasing the number of conformations to be examined, by decreasing the total computing time to be spent evaluating a specific molecule, and by using a Connolly surface plus 3 angstroms instead of plus 0.2 angstroms, or by using only an electrostatic search using spatials as a first screen.

Another parameter which affects search duration is the time out feature which is present and in Unity® available through Tripos, Inc. The timeout feature establishes the amount of time searching or examining a molecule to determine if it meets the established search criteria. It is advantageous to choose the amount of time in order to optimize search parameters for molecules using spatials, Connolly surfaces and nucleic acid excluded volume shapes associated with a biological activity. In one embodiment, the search time is set at about 60 seconds. In another embodiment, the search time is set at about 120 seconds. However, it is to be understood that the search duration may be adjusted by one of ordinary skill in the art at 36, taking into account variables such as computing speed and memory, complexity of the spatials, Connolly surface and nucleic acid excluded volume shapes. In practice, the search is fastest with the least number of spatials, followed by nucleic acid excluded volumes, followed by the Connolly surface.

Partial Match Constraints

Another modification that the operator may select as part of the configuration at 36 involves the spatials and can be accomplished through Sybyl®. This feature is called partial match constraints, and permits selection of subsets of spatials associated with a set of molecules of specific biological activity. For example, in the case of a sedative search engine which has three spatials, a criterion may be established for requiring heteroatoms (donor or acceptor atoms) on a molecule being evaluated to fit two of the three spatials. Choosing this partial match constraint feature permits a less rigorous search which has value in producing faster search results, especially when searching large molecular databases, and a preliminary list of molecules that may be evaluated further using all the spatials in another search. Often, the most active molecules fit all spatials associated with a specific biological activity and less active molecules fit partial matches.

Search Strategy

Although various search strategies, or combinations thereof may be employed in the practice of the present invention, the following list is a preferred order of criteria used in using a search engine, from preferred (1) to most preferred (4). These criteria, and combinations thereof, are executed by a search engine and may be considered configured as separate search engines.

Search engine 1. Spatials alone (I) and or partial match spatials

Search engine 2. Spatials (I) followed by Nucleic Acid Exclusion Volume Shape (II)

Search engine 3. Spatials (I) followed by Connolly Surface (III)

Search engine 4. Spatials (I) followed by Nucleic Acid Exclusion Volume (II) followed by Connolly Surface (III)

A fifth search engine involves the combination of the Connolly Surface (III) and the Nucleic Acid Exclusion Volume (II). If molecules did not fit this search engine, they would be unlikely to possess the biological activity associated with the search engine. This search engine also provides design information in that the basic molecular skeleton is provided and the functional groups are added to the molecular skeleton.

When two or more criteria are used for a search engine, the molecules which are identified by the search engine fit all criteria simultaneously. When the search is conducted stepwise, all criteria must be met in the final hit. In practice a molecule which fits a given spatial search (I) may be reoriented in space to fit a spatial plus Connolly search (III). In other words, there is more than one way to fit the molecule electrostatically but perhaps only one molecular orientation to fulfill other criteria.

Boolean subtraction may be employed with the search engines to remove molecules which fit within small or reduced Connolly surfaces from those fitting within the larger Connolly surfaces. This eliminates molecules too small to be considered further. This approach may be employed as a method of further refining the molecules identified with the present method.

In addition to the ability to refine searches by employing one or more components of the search engines (spatials, nucleic acid exclusion volume, Connolly surface), or by refining a component (partial matches of spatials or expansion or contraction of Connolly surfaces), the system 10 according to an embodiment of the invention encompasses application of more than one search engine, or a component thereof, for evaluation of more than one biological activity. An example is presented in Table 1.

The system 10 provides a rapid and efficient method for identifying molecules that are candidates for further biological testing and evaluation for possessing the specific biological activity. Use of the system 10 and method 30 of the present invention to evaluate large numbers of molecules rapidly produces a relatively short list of molecules for further biological testing for possessing one or more biological activities.

Analysis of Fit

Orientations of molecules which are identified by the search engine are used to quantitate relative fit to an index molecule of known biological activity using previous methods as described in U.S. Pat. No. 5,705,335. As discussed above, an index molecule is selected based on its known biological activity and its use in creation of the spatial and Connolly surface. An example of an index molecule is estradiol for the estrogen search engine.

Design of Molecules

Once a molecule is identified by a search engine, it can then be visualized as to what criteria it satisfied, i.e. where did it hit the spatial, how large is the molecule, how the molecule can be modified to affect fit. For example, electrostatic fit can be increased by changing the hydrogen bonding functional group to improve charge. The structure may be modified by adding various chemical groups to improve the volume of fit within the Connolly surface. Changes in ring patterns and or modifications to limit conformational flexibility in a given part of the structure can be performed to improve electrostatic and/or surface fit. In practice, searches of large databases with specific search engines frequently identify completely unexpected structures. For example, the sedative search engine described herein, which was constructed based on steroidal anesthetics, identified melatonin, thalidomide, amobarbital and cyclopenol which are structurally unrelated to the steroids. Similarly, trans-diethylstilbestrol, indenestrol, genistein and zearalanol were identified with the estrogen search engine and these are not structurally related to the steroidal estrogens used to create the search engine. The antibiotic (Cipro) search engine, described herein, identified ampicillin, a molecule structurally unrelated to the drugs such as ciprofloxacin and other fluoroquinolones used as standards to construct the Cipro search engine. Ampicillin has been shown previously to have anti-anthrax biological activity, thereby providing validation of the predictive ability of the Cipro search engine. These surprising and unexpected results demonstrate some of the novel and non-obvious features of the present invention.

In the following paragraphs, it is assumed that the Connolly surface is the included volume surface which does not overlap with the excluded volume surface of a search engine. More specifically, molecules which have portions that extend into the excluded volume do not fit the search criteria and would not be designed.

Databases may be screened with the method 30 of the present invention to locate structures likely to have a given biological activity. Such biological activity could be unknown, suspected or already established in the literature. Unknown structures predicted to be active are procured and/or synthesized and the predicted biological activity(ies) confirmed by appropriate biological assays. Structures with suspected activities are exemplified by the following non-limiting situations: a) compounds/drugs having a given activity but thought to have a given non target activity or side effect (e.g., anecdotal evidence). The side effect is confirmed or detected by the search engine and later confirmed by subsequent testing; b) active natural product mixtures or extracts in which the structural components are known but the active ingredient is unknown. In such cases the search engine identifies the active ingredient, e.g., genistein as an estrogen in soybean extracts; c) natural product mixtures or extracts in which the structural components are unknown but a general class is either unknown or suspected. In such cases, the search engines identify an active structure which then is identified in the chemical analysis of the mixture or extract, e.g., a grape extract with antineoplastic activity thought to contain stilbenes might contain a specific stilbene which hits the search engine. In this manner, the search engine provides likely leads of compounds, e.g., a specific stilbene with antineoplastic activity, resveratrol, later found to be present in the extract; d) patent claims often contain generic and subgeneric structures in which a given structural skeleton is provided with multiple substitutions or R groups (e.g. analogs, stercoisomers etc.). Many of the individual molecular structures, or species of the generic structure, are often not made and tested, yet the biological activities are claimed. The search engines help identify which such individual molecular structures, or species of the generic structure, are likely to be active as well as which structures are likely to be inactive.

Once a given candidate structure likely to be active is identified by a search engine, analogs (including stereoisomers) can be constructed. These analogs can be: a) structures designed by better fit into the search engine e.g. better electrostatic fit to the spatials or better volume fit within the Connolly surface. An example of this is shown in FIGS. 4 and 5. 11β-methoxy-7α-methylestradiol (PDC-7), a molecule identified by the estrogen search engine, is a better volume fit into the Connolly surface of the search engine than an index molecule estradiol. PDC-7 was predicted to be more active than estradiol and was subsequently demonstrated to possess greater estrogenic bioactivity than estradiol (Medicinal Chemistry Research 10:440-455, 2001); or b) structures derived by a systematic substitution of various atoms and functional groups (e.g. methyl, ethyl, chloro, hydroxyl, etc.) on the basic skeleton. Appropriate atoms and functional groups are commonly known to one of ordinary skill in the art of molecular modeling. These analogs are added to a database and searched using the search engine to determine whether any of the analogs are identified by the search engine. The manner of fit is then compared to the initial candidate structure to determine whether or not it is an improved fit (e.g. better spatial or volume fit) and thus predicted to be more active. This process can be automated.

Molecules are designed de novo from the search engines by placing various chemical structures within the spatial and volume requirements and adding or subtracting atoms or functional groups to better fit the search engine criteria. The search engine components, that is the spatials, included volume and excluded volume, alone or in combination, define a molecular skeleton useful for designing new molecules with a likelihood of possessing a biological activity. If the new molecule fits along the molecular skeleton, it has a potential for the biological activity associated with the molecules of known biological activity that were used in the creation of the search engine. Molecules are also designed by using the Connolly surface alone to search databases for basic structures which fit within the volume of the Connolly surface. Once a given candidate is identified, it is modified structurally by adding or subtracting atoms or functional groups to fit the electrostatic spatials and/or to better fit the Connolly surface. In one embodiment of the present invention, a basic structural nucleus, for example that of thalidomide, is constructed. Next, one or more functional groups are added and the effect of the addition of the one or more functional groups is evaluated with the search engines, for example the sedative search engine, to determine if the modified thalidomide molecule fits within the criteria for that search engine or combinations of search engine. In this manner, new molecules are designed and evaluated for the likelihood of possessing one or more biological activities, such as sedative activity and/or anti-mitotic activity.

Molecules are also designed by using the one or more spatials from a search engine to search a database for candidate structures. Once a candidate is identified, additional functional groups are added to better fit the spatials. Alternatively, or in addition, additional functional groups are added to better fit into the Connolly surface.

Recommended Biological Tests for Candidate Molecules Identified or Designed Using the Method of the Present Invention

In one embodiment of the present invention, the candidate molecules identified or designed are provided together with a set of recommended test systems for evaluating the predicted biological activity or activities of the molecule. Such recommended test systems may include any test appropriate for evaluating the biological activity. Such tests are known to one of ordinary skill in the art. The following paragraphs provide non-limiting examples of tests that may be used for selected biological activities.

Estrogenic biological activity In the case of suspected estrogenic biological activity, such tests may include but are not limited to the following: in vivo tests of uterotrophic activity, ability to modulate luteinizing hormone synthesis and/or release, ability to modulate luteinizing hormone-releasing hormone synthesis and/or release, ability to stimulate growth of ovarian follicles, fat deposition, modulation of onset of puberty; in vitro tests such as modulation of growth of estrogen sensitive cells, competitive effects on binding to estrogen receptors; angiogenesis, neuroprotection, stroke prevention. It is to be understood that other tests for evaluation of estrogenic activity, as known to one of ordinary skill in the art, may be employed and are included within the scope of the present invention.

Androgenic activity A variety of tests are available to one of ordinary skill in the art for evaluating androgenic activity of molecules. These include, but are not limited to the following: chicken comb assay, growth of ventral prostate, growth of muscles, fertility, sperm count and motility, decrease in serum luteinizing hormone.

Sedative activity A variety of in vitro tests are available to one of ordinary skill in the art for evaluating sedative activity of molecules. These include, but are not limited to the following: a) receptor binding e.g., measure radiolabeled flunitrazepam displacement by candidate drug; b) electrophysiological assays such as drug enhancement of muscimol dependent chloride uptake into synaptosomes, patch clamp e.g., potentiation of GABA responses in whole cells using human recombinant cDNA GABA-A receptor subunits transfected into various cell types: Xenopus laevis oocytes, Chinese hamster ovary cells, human embryonic kidney cells (HEK-293), measurement of IPSC's (inhibitory post synaptic currents) using dissociated neurons or cultured neurons from substantia nigra reticulata, hippocampus, cerebellum, cortex, and other regions, using rat brain slices, or using human NT2-N neuronal cells.

A variety of in vivo tests are available to one of ordinary skill in the art for evaluating sedative activity of molecules. These include, but are not limited to the following: a) anxiolytic effect, e.g., Vogel's conflict test, plus maze test, or aggressiveness reduction; b) sedative effect, e.g., ataxia—Rotarod test, cognitive impairment—male learning retention tests, hypnotic effect—potentiation of pentobarbital sleep; and c) anticonvulsant effect, e.g., inhibition of pentylenetetrazol or electric shock induced convulsions (mice/rats), reduction in ethanol withdrawal induced seizures.

Anti-depressant activity A variety of in vitro tests are available to one of ordinary skill in the art for evaluating anti-depressant activity of molecules. These include, but are not limited to the following: a) receptor binding e.g., serotonin (5HT), norepinephrine (NE) and dopamine (DA) receptor subtype radioligand binding techniques; b) reuptake assay—measure drug-induced inhibition of 5HT, NE, DA and corticotropin releasing factor (CRF) reuptake into synaptosomes; and c) attenuation of long term potentiation induction in rat hippocampi.

A variety of in vivo tests are available to one of ordinary skill in the art for evaluating anti-depressant activity of molecules. These include, but are not limited to the following: a) animal models of depression, e.g., learned helplessness, behavioral despair (forced swim test, for example the Porsolt Test), intracranial self stimulation, and social isolation; and b) in vivo measurement of neurotransmitter release, including but not limited to DA, NE, or 5HT.

Antibiotic Activity

A variety of in vitro and in vivo tests are available to one of ordinary skill in the art for evaluating antibiotic activity of molecules, particularly anti-anthrax activity. Some of these commonly known methods are described in U.S. Pat. Nos. 6,180,604, 6,165,997, 6,267,966, 6,159,719 and 5,840,312, which are incorporated by reference herein in their entirety.

Anti-Angiogenic or Angiogenic Activity

Biological assessment of predicted anti-angiogenic or angiogenic activity of a compound may be performed using currently available assays known to one of ordinary skill in the art. These assays and methods include, but are not limited to the following: the chick chorioallantoic (CAM) assay (Crum et al., Science 230: 1375-1378, 1985; Gagliardi et al., Cancer Research 52: 5073-5075, 1992; and Gagliardi et al., Cancer Research 53: 533-535, 1993); inhibition or proliferation of capillary endothelial cells or fibroblasts (Fotsis et al., Nature 368: 237-239, 1994); the human umbilical vein endothelial cell assay (Morales et al., Circulation 91: 755-763, 1995); in vivo vascularization of Matrigel plugs (Morales et al., Circulation 91: 755-763, 1995); and inhibition of metastasis of Lewis lung carcinoma (O'Reilly et al., Cell 79: 315-328, 1994).

Osteoporosis or Osteogenesis Activity

Molecules may be tested for osteoporotic or osteogenic bioactivity using techniques known to one of ordinary skill in the art. Some of these techniques are revealed in the publication by Jardine et al., Ann. Reports in Medicinal Chem. J. A. Bristol ed., 31:211-220, 1996, and Delmas et al., New England J. Med., 337:1641-1647, 1997. Such techniques include, but are not limited to the following, evaluation of bone density, evaluation of bone mineral density and measurement of various biomarkers related to bone physiology.

Bone density may be determined by evaluating the density of selected bones such as the vertebrae, tibia, femur, pelvis, radius, ulna, humerus or any other selected bone useful for measuring bone density. Imaging techniques such as computerized assisted tomography, commonly known to one of ordinary skill in the art, may be employed to measure bone density.

Bone mineral density may be evaluated by dual-energy x-ray absorptiometry as taught by Delmas et al., New England J. Med., 337:1641-1647, 1997. Biochemical markers of bone turnover, such as serum osteocalcin, bone-specific alkaline phosphatase, and the ratio of urinary type I collagen C-telopeptide to creatinine may also be measured as taught by Delmas et al., New England J. Med., 337:1641-1647, 1997, and also in selected references cited therein. Increased bone density following administration of a molecule of the present invention indicates bone-protective effects of a molecule. Decreased bone density following administration of a molecule of the present invention indicates potential osteoporotic or bone-wasting effects of a molecule. It is to be understood that the biological activity of the molecules of the present invention may be evaluated using other biological markers related to bone physiology as known to one of ordinary skill in the art.

Computing Considerations: Description of the System

The system 10 facilitates rapid evaluation of compounds for predicted biological activity. As mentioned above in conjunction with the description of FIG. 1, the system 10 may be used in various network environments. The system 10 includes a processor which may include, but is not limited to, a desktop personal computer, a laptop computer, a parallel computing cluster, a digital tablet, a PDA, or a multi-user server system. The user device 5 has an output device for displaying information from the system 10, such as monitors, printers, liquid crystal displays, and other output devices known to one of skill in the art.

The system 10 may receive information concerning a molecule to be evaluated through different channels. For example, information concerning a molecule may be manually input into the system 10. Information concerning one or more molecules may be contained in a database 15. Such database 15 may be located within the system 10 within storage. Optionally, database information may be loaded into computer memory or read from a computer readable medium. Information concerning a substance or molecule may be contained on any computer readable medium known to one of ordinary skill in the art. Such media may include, but are not limited to a disk, tape, CD, DVD, flash memory or other medium capable of being read by a reading device and/or accessed by the system 10. In another embodiment, the system 10 may access information contained in a second computer located external to the system 10 through the network 12. In another and preferred embodiment, the system 10 may, through the network 12, access information contained in a database 15 located external to the system 10. Such databases 15 may be located anywhere, for example on the web site or server of an organization or company.

The network 12 enables the system 10 to access databases located remotely or for communicating with remote computers. The system 10 may include, but is not limited to, use of phone lines, modems, fax modems, cable, DSL, uplinks to a satellite, and T1 lines. The system 10 may also include transmitter and receivers compatible for communication with satellites.

All data concerning molecules may be placed in a form, such as a digitized form or other computer readable and communication acceptable form, and transmitted. In one embodiment, the data may be located in the system 10. In one embodiment, the data may be located in a remote computer. In another embodiment, the data may be located in the database 15 housed in a remote computer.

Another component in the system 10 is a transmission device such as a modem or other communication device known to one of skill in the art. Such devices include, but are not limited to satellites, telephones, cables, infrared devices, and any other mechanism known to one of skill in the art for transmitting information. The transmission device modem transmits information to the central computer-based database. In a preferred embodiment, modems are used for computer access to the Internet. Such devices may be essential for receipt and/or transmission of data concerning the substance to another facility housing the database 15. It is to be understood that the facility housing the database 15 may be located locally, in the same office, the same building, or across town, or at a remote location such as in another city, state, country, or on a ship, plane or satellite. The database 15 may also be located within the system 10 containing the search engines of the present invention, or may be accessed by the system 10 containing the search engines, for example by communicating with a peripheral storage device.

The system 10 may be configured to take advantage of data communications technologies and distributed networks, which makes it possible to deliver data to and receive data from virtually anywhere in the world in an efficient and timely manner. This system 10 in accordance with the present invention is capable of transferring data from a remote source to a central server via one or more networks 12. The central server hosts the search engines and related components. Accordingly, the central server is operable to analyze the received substance data using the analytical method of the present invention, in order to produce information related to predicted biological activity of the molecule. The resulting information may then be delivered from the central server to one or more remote locations housing computers or other graphical user interfaces or display devices via one or more networks 12. The entire process of transferring data from a remote source to a central server, analyzing the data at the central server to produce information, and transferring the information to a remote client site may thus be performed on-line and in real time.

An exemplary network architecture of an exemplary system 10 in accordance with the present invention is described below. The exemplary system 10 comprises one or more workstations 5 in communication with a server. The workstations 5 may be local, for example in a local area network (LAN), a distributed network, a peer to peer network, a virtual private network, or remote. The central server houses the search engines. The one or more workstations 5 function as remote access points to the central server hosting the search engines. A workstation 5 may be located within an intranet or LAN, in a distributed network, and/or at any other appropriate distant site. A workstation 5 may be configured for transmitting and/or receiving information to or from the central server in either an interactive mode or a batch mode.

Workstations 5 may comprise any type of computer-like device that is capable of sending and/or receiving data. For example, a workstation 5 may comprise a desktop computer, a lap top computer, a hand-held device, or the like, for transferring the data concerning the molecule to the central server for analysis of potential biological activity by a search engine. In one embodiment, an individual desiring to evaluate the potential biological activity of a substance may send chemical information about the substance, for example structural data or electrostatic data, to the search engine. The search engine then analyzes the substance for one or more predicted biological activities, using the search engines and strategies of the present invention, and produces a result comprising information about the predicted one or more biological activities. The result is then optionally transmitted to the individual or stored.

Computer Hardware Requirements

Any computer with sufficient memory and speed to manipulate molecular structures, produce different conformations of molecules and analyze molecular interactions may be used, such as a computer with hardware sufficient to run software capable of performing the operations necessary to practice the present invention. Preferably the computers are capable of running the Sybyl® programs available from Tripos Inc. of St. Louis, Mo. In one embodiment, the search engines are formed through journaling using Sybyl® Programming Language (“SPL”). The search engines are stored in a Tripos mo12 formatted file. The mo12 file (.mo12) is a complete, portable representation of a SYBYL molecule. It is an ASCII file which contains all the information needed to reconstruct a SYBYL molecule. Unity® is used for the three-dimensional database searching.

Different operating systems may be used, such as UNIX, LINUX or Windows NT. More preferred is a computer with RISC technology, or improvements thereupon which runs on a UNIX system. Silicon graphics computers or Hewlett Packard computers are some examples of suitable computers. Additionally, computers that operate LINUX are another suitable set of computers.

A computer with high end graphic capabilities is also preferred. It is to be understood that the present invention is not limited to use of these preferred hardware devices, and that improvements thereto and new programs may serve the same functions required to practice the present invention.

Computer Software Requirements

Any computer program capable of performing the manipulations and calculations described above may be used with the present invention. A preferred program is Sybyl® from Tripos, Inc., preferably Sybyl 6.7 or a more advanced version, a program called Unity® from Tripos, preferably version 4.2 or higher, and Molcad® provided in the Sybyl® package by Tripos, Inc. It is to be understood that the present invention is not limited to use of these preferred software programs, and that improvements thereto and new programs may serve the same functions required to practice the present invention. For example, the search engines may employ software available from Accelrys of San Diego, Calif., such as Insight II® and Discovery Studio®.

System Configuration

The following description provide some additional examples on how the system 10 may be configured. A first workstation 5 may be configured to transmit data to a the central server hosing the search engine via a communications link and a second workstation 5 may be configured to receive processed data (results) from the central server via the communications link. A workstation 5 may implement various user interface, printing and/or other data management tasks and may have the ability to store data at least temporarily.

The communications link may comprise a dedicated communications link, such as a dedicated leased line or a modem dial up connection. Alternately, the communications link may comprise a network, such as a computer network, a telecommunications network, a cable network, a satellite network, or the like, or any combination thereof. The communications link may thus comprise a local area network, distributed network and/or one or more interconnected networks. In a workstation embodiment, the communications link may comprise the Internet. As should be apparent to those of skill in the art, the communications link may be land-line based and/or wireless. Communications over the communication link between the client station and the central server may be carried out using any well-known method for data transmission, such as e-mail, facsimile, FTP, HTTP, and any other data transmission protocol.

In another embodiment, a portable PALM like device or small computer can contain the search engines and/or a series of databases that may be downloaded to a larger computer or employed on a network.

The central server comprises the computer-based search engines and may contain the database of molecular information. The central server implements the functions of the search engines. The central server also receives information from a user, such as modification of the angstrom limitations on a Connolly surface, or utilization of one or more components of the search engines, and implements the modifications before performing a modified search. The central server may house the molecular database information or may access it through a network linked to another computer or peripheral storage device housing the molecular database information. It will be apparent to those of skill in the art, however, that the communication station and the computation station may be implemented in a single computer. The configuration of an exemplary central server will be described in greater detail below.

A system in accordance with an exemplary embodiment of the present invention may operate in an interactive mode or a batch mode. In the interactive operating mode, molecular information is processed one by one interactively. For example, in an interactive processing mode, a user connects to the central server through a workstation. A data sample to be processed, for example a molecular structure and associated electrostatic information, is then sent from the workstation to the central server. The processed data (result file) is returned from the central server to the workstation, where it may be printed, visualized and/or archived. After the result file is received at the workstation, a subsequent data sample may then be transmitted from the workstation to the central server.

An exemplary system configured for an interactive processing mode is now described. A workstation may be configured for execution of a communication browser program module and one or more printing and/or archiving program modules. As is known in the art, a convenient and effective communication link for facilitating interactive operations is the Internet. Communication browsers are also known as World-Wide-Web browsers or Internet browsers.

The components of the central server may be distributed among two stations, a communications station and a computation station. Configured for an interactive processing mode, the communications station may comprise a communications server, such as a standard http server, for interacting with the communication browser executed at the workstation. Communications between the communications server and the communication browser may occur using html pages and Common Gateway Interface (CGI) programs transferred by way of TCP/IP.

The central server may also house information concerning suggested biological tests useful for evaluating the predicted biological activity of a molecule identified with the search engines, whether the molecule is identified through screening or designed de novo. Further, the central server may contain links to other information concerning suggested manufacturers of the molecule, whether the molecule is commercially available, and if so its cost, information in chemical indexes, information concerning the safety, storage and handling standards associated with the molecule, and information in the scientific and technical literature associated with the molecule. In this manner, if a molecule is identified using a search engine and the molecule is known, additional information is available for the user to facilitate purchasing decisions, decisions concerning safety and storage and other decisions. If the molecule is not available, the user may be directed to a list of chemical manufacturers for placing an order. For example, the NCI and Maybridge 3-dimensional databases available from Tripos, can be screened with the search engines of the present invention. Once a molecule is identified by a search engine, the structure can then be further analyzed. In the case of molecules found in hit lists from the NCI three dimensional database, the Chemical Abstract Number associated with that structure can be used to search the online internet NCI database browser. In this manner, additional information (if known) can be obtained concerning the molecule in the online database or in associated links, e.g. the biological activities in tumor cell culture, chemical properties, commercial availability, etc. Similarly, molecules identified from searches of the Maybridge 3-dimensional database have designated alphanumerical numbers which can then be used to search the online Internet Maybridge chemical database. The Maybridge database provides chemical information about the compounds and commercial availability.

Billing Feature

The present invention further includes an optional billing component. This component enables the provider of the evaluation of molecules for suspected biological activity or the molecular designer with the option to determine the charge for performing the evaluation or design. The charge is determined and then optionally transmitted to the individual or entity requesting the evaluation. The charge may be transmitted in the form of an invoice sent to the individual by mail, by e mail, by facsimile or through other means. Alternatively, the individual or entity may authorize a charge to be billed to a credit card. In another embodiment, the charge may be debited from an account. Whatever billing option is selected, the relevant information required for the billing to occur is input into the system. Information concerning costs of evaluating or designing molecules in stored in the central server.

The following examples will serve to further illustrate the present invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention.

### EXAMPLE 1

Evaluation of Substances for Predicted Estrogenic Biological Activity

The following nine estrogens of known estrogenic biological activity listed as standards in Table 1 and the conformation of the partially unwound double stranded DNA site into which they fit, 5′-dTdG-3′5′-dCdA-3′, were used to construct the estrogen search engine (spatials, Connolly surface and nucleic acid exclusion volume shape): estradiol; 11β-methoxyestradiol; 11β-formoxyestradiol; 11β-acetoxyestradiol; estradiol-11 beta-nitroester; 7α-methylestradiol-11β-nitroester; 17α-ethynylestradiol; 17α-chloroethnylestradiol; moxestrol (11β-methoxy-17α-ethynylestradiol); and, 17α-iodovinyl-(Z)-11β chloromethylestradiol.

The following compounds were identified using the estrogen search engine: PDC-7 (11β-methoxy-7α-methylestradiol); trans-diethylstilbestrol; genistein (phytoestrogen); equol (phytoestrogen); daidzein (phytoestrogen); zearalanol (phytoestrogen); Horeau's acid; and indenestrol. All of these molecules are estrogenic.

The estrogenic steroids were docked into spaces between base pairs in double stranded DNA using a sequence (5′-dTdG-3′5′-dCdA-3′) and partially unwound conformation which best forms a complex with the ligands. The spatial was created from the positions of the heteroatoms on the DNA that form hydrogen bonds to these estrogens i.e. two electrostatic points corresponding to the 3 hydroxyl group and the 17β hydroxy group of the estrogens which form stereospecific linkages to the phosphate groups on adjacent DNA strands. The spatials are constraints into which appropriate hydrogen bonding heteroatoms of functional groups on a candidate structure must fit to be considered a hit by the search engine. The surface of the partially unwound DNA into which the molecules were docked was used as an excluded volume i.e. a candidate molecule was not permitted to fit into this space. A Connolly surface of the composite surfaces of these estrogens was created from the composite of all of the active molecules. This surface was created initially at 3 angstroms distance beyond, or greater than, the Connolly surface. Databases were searched for compounds that fit inside this Connolly surface, did not violate the excluded volume surface and possessed heteroatoms that fit within the spatials emanating from the heteroatoms on DNA. It is also possible to use the spatials and Connolly surfaces either independently and/or in combination with the excluded volume surface to search various databases.

The estrogen search engine was then employed to search databases containing a variety of compound structures (Table 1). In these searches the extended volume for the Connolly surface was 1.5 angstroms. The number of starting conformations for molecules to be searched was set at 20. All of the estrogen standards used to create the search engine hit the search. In addition, PDC-7(11β-methoxy-7α-methylestradiol); trans-diethylstilbestrol; genistein (phytoestrogen); equol (phytoestrogen); daidzein (phytoestrogen); zearalanol (phytoestrogen); Horeau's acid; and indenestrol were identified by the search. PDC-7 was not used in creation of the search engine and is an estrogenic steroid with greater potency than the natural estrogen estradiol. Trans-diethylstilbestrol is also a potent estrogen but does not possess a steroid skeleton. Genistein, equol, daidzein and zearalanol are naturally occurring plant compounds which are also structurally unrelated to the estrogenic steroids but possess estrogenic activity. Horeau's acid and indenestrol are synthetic compounds also dissimilar to steroidal estrogens yet are estrogenic; the former compound was a commercial estrogenic drug. These results demonstrate that the estrogen search engine is effective in identifying compounds with estrogenic activity regardless of their structural motif.

In addition to correctly identifying estrogenic compounds, compounds not known to possess estrogenic activity did not hit the search engine (Table 1). These compounds are known to have antidepressant, sedative or androgenic activities (see examples below). In many cases compounds known not to possess estrogenic activity and or shown not to possess estrogenic activity did not hit the search engine. Thus, the estrogen search engine is specific for estrogenic activity.

FIG. 16 is an exemplary interface to the estrogen search engine. The estrogen search engine, including the spatials, excluded volume and/or included volume, is automatically stored within the system 10 using the save command and the search engine file is given the extension *.mo12. To begin a search, the read command is used to enter the appropriate .mo12 file, e.g. estrogensearchengine.mo12, into a workspace within Sybyl® e.g. “M1.” The dropdown menu named Unity® is accessed using the mouse and a given database is selected for searching e.g. the estrogen bioassay database. Alternatively, a given hit list from a previous search can be selected. The operator then checks OK which begins the search. The results of the search are then displayed to the user.

### EXAMPLE 2

Evaluation of Substances for Predicted Androgenic Biological Activity

The following nine androgens of known androgenic biological activity, listed as standards in Table 1, and the conformation of the partially unwound double stranded DNA site into which they fit, 5′-dTdG-3′5′-dCdA-3′, were used to construct the androgen search engine (spatials, Connolly surface and nucleic acid exclusion volume shape): testosterone; 7α-methyltestosterone; 19-nortestosterone; 7α-methyl-19-nortestosterone; 5α dihydrotestosterone; 7α-methyl-5α dihydrotestosterone; 5α dihydro-19-nortestosterone; 17α-methyl-5α-dihydrotestosterone; 7α-methyl-19-nor-5αdihydrotestosterone; 17α-methyl-19-nor-5α dihydrotestosterone; and, 7α-methyl-17α-methyl-19-nor-5α dihydrotestosterone.

The androgenic steroids were docked into spaces between base pairs in double stranded DNA using a sequence (5′-dTdG-3′5′-dCdA-3′) and partially unwound conformation which best forms a complex with the androgenic steroids. The spatial was created from the positions of the heteroatoms on the DNA that form hydrogen bonds to these androgens, i.e. two electrostatic points corresponding to the 3 carbonyl group and the 17β hydroxy group of the androgens which form stereospecific linkages to the phosphate groups on adjacent DNA strands. The spatials are constraints into which appropriate hydrogen bonding heteroatoms of functional groups on a candidate structure must fit to be considered a hit by the search engine. The surface of the partially unwound DNA into which the molecules were docked was used as an excluded volume i.e. a candidate molecule was not permitted to fit into this space. A Connolly surface of the composite surfaces of these androgens was created from the composite of all of the active molecules. This surface was created initially at 3 angstroms distance beyond, or greater than, the Connolly surface. Databases were searched for compounds that would fit inside this Connolly surface, do not violate the excluded volume surface and possess heteroatoms that fit within the spatials emanating from the heteroatoms on DNA. It is also possible to use the spatials and Connolly surfaces either independently and/or in combination with the excluded volume surface to search various databases.

The androgen search engine was then employed to search databases containing a variety of compound structures (Table 1). In these searches the extended volume for the Connolly surface was 1.0 angstrom. All of the androgen standards used to create the search engine were identified by the search. In addition, mibolerone, a potent androgen with greater potency than the natural androgen testosterone but which was not used to create the search engine was identified by the search engine. These results demonstrate that the androgen search engine is effective in identifying compounds with androgenic activity.

In addition to correctly identifying androgenic molecules, molecules not known to possess androgenic activity were not identified by the search engine (Table 1). These compounds are known to have antidepressant, sedative or estrogenic activities (see examples below). Thus, the androgen search engine is specific for androgenic biological activity. In many cases compounds known not to possess androgenic activity and or shown not to possess androgenic activity did not hit the search engine.

### EXAMPLE 3

Evaluation of Substances for Predicted Sedative Biological Activity

The following four steroids, listed as standards in Table 1, which are known to possess sedative activity, alphaxalone, 3α, 5α-tetrahydroprogesterone, 3β,5α-tetrahydroprogesterone and ganaxolone and the conformation of the partially unwound double stranded DNA site into which they fit, 5′-dTdG-3′5′-dCdA-3, were used to construct the sedative search engine (spatials, Connolly surface and nucleic acid exclusion volume shape).

The sedative steroids were docked into spaces between base pairs in double stranded DNA using a sequence (5′-dTdG-3′5′-dCdA-3′) and partially unwound conformation which best forms a complex with the sedative steroids. The spatial was created from the positions of the heteroatoms on the DNA that form hydrogen bonds to these sedatives, i.e. two electrostatic points corresponding to the 3 hydroxyl group and the 20 carbonyl group of the steroids which form stereospecific linkages to the phosphate groups on adjacent DNA strands. In addition, a spatial was created from a water molecule connecting the O₄ of thymine and the 11 carbonyl group of alphaxalone via hydrogen bonding linkages. The three spatials are constraints into which appropriate hydrogen bonding heteroatoms of functional groups on a candidate structure must fit to be considered a hit by the search engine. Partial matches to two of the three spatials have also been employed as constraints in the sedative search engine (Table 1). The surface of the partially unwound DNA into which the molecules were docked was used as an excluded volume i.e., a candidate molecule is not permitted to fit into this space. A Connolly surface of the composite surfaces of these sedatives was created from the composite of all of the active molecules. This surface was created initially at a 3 angstroms distance beyond, or greater than, the Connolly surface. Databases were searched for compounds that would fit inside this Connolly surface, did not violate the excluded volume surface and possessed heteroatoms that fit within the spatials emanating from the heteroatoms on DNA and the water bridge. It is also possible to use various combinations of the spatials and Connolly surfaces either independently and/or in combination with the excluded volume surface to search various databases.

The sedative search engine was then employed to search databases containing a variety of molecular structures (Table 1). In these searches the extended volume for the Connolly surface was 1.5 angstroms. Partial match constraints were also employed. Specifically, a molecule was considered a hit if it hit all three spatial constraints or two of the three spatials. All of the sedatives standards used to create the search engine were identified by these searches. Alphaxalone, the most potent steroidal sedative, hit all three spatials, whereas the sedatives 3α, 5α-tetrahydroprogesterone, 3β, 5α-tetrahydroprogesterone and ganaxolone hit two of the spatials. Compounds structurally unrelated to the steroid which were employed in the creation of the search engine but which possessed sedative activity also were identified by the search. Such identifications included very diverse structures i.e. the nucleoside adenosine, the benzodiazepine brotizolam, the indole melatonin, the cannabinoid delta 9 tetrahydrocannabinol, the phenyl benzoxazine etifoxine and the barbituates amobarbital and butalbital. Of particular interest is the benzodiazepine cyclopenol which occurs naturally in certain microorganisms. Thalidomide, a compound previously marketed as a sedative, also was identified by the search engine. The antidepressant paroxetine hit all three spatials and is known to be sedating. These results demonstrate that the sedative search engine is effective in identifying compounds with sedative activity. These results also indicate that collectively, each of the search engines is capable of selecting candidates likely to have a given biological activity, as well as detecting compounds with multiple biological activities. In this manner, the likely side effects of a given compound(s) can be assessed.

In addition to correctly identifying sedative compounds, compounds not known to possess sedative activity did not hit the search engine (Table 1). These compounds are known to have antidepressant, androgenic or estrogenic activities but not sedative activity. Thus, the sedative search engine is specific for selecting compounds with sedative activity.

### EXAMPLE 4

Evaluation of Substances for Predicted Anti-Depressant Biological Activity

The following eight molecules of known anti-depressant biological activity, listed as standards in Table 1, were used to construct the anti-depressant search engine (spatials, Connolly surface and nucleic acid exclusion volume shape): imipramine; fluoxetine; sertraline; maprotiline; amitriptyline; nomifensin; iprindole; and, chlomipramine.

These antidepressants were docked into spaces between base pairs in double stranded DNA using a sequence (5′-dTdG-3′5′-dCdA-3′) and partially unwound conformation which best forms a complex with the ligands. The spatial was created from the position of the heteroatoms on the DNA that form hydrogen bonds to these antidepressants i.e. one electrostatic point corresponding to the amino group of the antidepressants and the O₆ of guanine. The spatial is a constraint into which appropriate hydrogen bonding heteroatoms of functional groups on a candidate structure must fit to be considered a hit by the search engine. The surface of the partially unwound DNA into which the molecules were docked was used as an excluded volume, i.e. a candidate molecule was not permitted to fit into this space. A Connolly surface of the composite surfaces of these antidepressants was created from the composite of all of the active molecules. This surface was created initially at a 3 angstroms distance beyond, or greater than, the Connolly surface. Databases were searched for compounds that fit inside this Connolly surface, did not violate the excluded volume surface and possessed heteroatoms that fit within the spatials emanating from the heteroatoms on DNA and the water bridge. Various combinations of the spatials and Connolly surfaces are also used either independently and/or in combination with the excluded volume surface to search various databases.

The antidepressant search engine was then employed to search databases containing a variety of compound structures (Table 1). In these searches the extended volume for the Connolly surface was 0.7 angstroms. All of the antidepressants used to create the search engine were identified by these searches. In addition, antidepressants having a wide variation in structure and not used in the creation of the search engine were identified by the searches including fantridone, buproprion, reboxetine, venlafaxine, fluvoxamine, etifoxine and paroxetine. Of particular interest is the sedative thalidomide which is identified by both the sedative and antidepressant search engines. Thalidomide is known to possess both sedative and antidepressant/anxiolytic activity. As stated previously, the antidepressant/anxiolytic etifoxine also was identified by the sedative search engine and is known to have sedative activity. Taken as a whole, these results indicate that each of the search engines is capable of selecting candidates likely to have a given biological activity as well as detecting compounds with multiple activities. In this manner, it is possible to assess likely side effects of a given compound(s).

In addition to correctly identifying antidepressant compounds, compounds not known to possess antidepressant activity did not hit the search engine (Table 1). These compounds are known to have androgenic or estrogenic activities but not antidepressant activity. Thus, the antidepressant search engine is specific for selecting compounds with antidepressant activity.

### EXAMPLE 5

Operation of the System Over the Web for Maybridge and National Cancer Institute (NCI) Databases Using Several Search Engines

The NCI database containing about 117,649 structures and the Maybridge database containing about 61,184 structures were searched using antidepressant, antidiabetic, progestin, thyroid, estrogen, androgen, bone, (selective estrogen receptor modifier (SERM)), sedative and glucocorticoid search engines. The conditions of the components of the search engines are shown in Table 2 and indicate the number of spatials, whether the nucleic acid exclusion volume was employed, whether the Connolly surface was employed, and if so, the variations in the Connolly surface (in angstroms).

The results demonstrate that the method of the present invention rapidly identifies molecules that form a subset of the total number of molecules found in each database. For example, the bone search engine, using spatials alone, identified 645 molecules from 117,649 in the NCI database as candidates for possessing bone bioactivity. This represents about 0.55% of the total number of molecules. Further refinements of the search strategy for bone can be added, such as use of the nucleic acid exclusion volume or the Connolly surface.

The antidiabetic search engine, using one spatial, identified 76,613 structures from 117,649 (67%). However, by adding the nucleic acid exclusion volume and the Connolly surface plus 1 angstrom, only 1650 structures were identified, representing about 1.4% of the molecules searched.

The androgen search engine, using 2 spatials, identified 15,133 molecules representing 13% of the molecules searched. Further refinement of the androgen search engine, by adding the nucleic acid exclusion volume and the Connolly surface plus 2 angstroms, identified 2,122 and 423 molecules representing 1.1% and 0.7% of the molecules searched, respectively.

The sedative search engine, employing 3 spatials and the nucleic acid exclusion volume identified 13,051 (11.1%) of the molecules searched. As shown in Table 2, addition of the Connolly surface and its further refinement from 3 to 1.7, 1.4, 1, and 0.7 angstroms identified 3.9%, 2.8%, 2.4%, 1.4% and 0.8% of the molecules searched in the NCI database, and 4.1%, 2.5%, 1.6%, and 0.8% of the molecules searched in the Maybridge database, respectively.

The antibiotic (Cipro) search engine, employing 2 spatials, the Connolly surface plus 2 angstroms and the nucleic acid exclusion volume identified 1662 (1.4%) of the 117,649 molecules searched in the NCI database.

### EXAMPLE 6

Anthrax Antibiotic Search Engine

Using the program Sybyl 6.7 (Tripos Associates, St. Louis, Mo.), a search engine, hereinafter called a Cipro search engine, was constructed by docking ciprofloxacin and active analogs (Table 1 and FIG. 10) into partially unwound DNA using the sequence 5′-dCdG-3′.5′dCdG-3′. The DNA was built by unwinding the known x-ray crystallographic model of DNA which binds with intercalated antibiotic bisdaunorubicin (Robinson et al., Biochemistry 36:8663-70, 1997). The bisdaunorubicin was removed and torsional angles on the DNA backbone were adjusted to best accommodate the fluroquinolones analogs. The analogs were docked into the DNA site (FIG. 10) by monitoring and optimizing pairs of hydrogen bonds formed between phosphate groups on adjacent DNA strands and the amino (NH⁻OP) and carboxylic acid groups (COO⁻HOP) of the index cipro analogs (standards). Automonitor was used to prevent van der Waals surfaces of atoms on the analogs and DNA from approaching too closely i.e., violating van der Waals distances.

The cipro search engine contains three components: spatial electrostatic constraints into which appropriate donor/acceptor atoms on a given ligand must fit; an excluded volume which cannot be penetrated by any candidate ligand; a Connolly surface into which an entire candidate ligand must fit. Two spatial constraints (FIGS. 10C, 11A, 12) corresponding to protonated and negatively charged phosphate oxygens bordering the unwound site were created. The spatial constraints represent a range of potential hydrogen bonds and were assigned a tolerance of 1 angstrom in width. The types of hydrogen bonds were limited to donor amino and acceptor carboxyl groups on candidate ligands. The excluded volume (FIGS. 10D, 11B, 12) was constructed from the atoms in the unwound DNA site into which the cipro analogs were docked. The standards docked into the site were the following: nalidixic acid; ciprofloxacin; fleroxacin, gatifloxacin; levofloxacin; lomefloxacin; moxifloxacin; norfloxacin; perfloxacin; sparfloxacin; trofloxacin. A Connolly surface (FIGS. 10E, 11C, 11D, 12) was constructed from the combined surfaces of the standards merged into a single workspace. The surface volume can be adjusted to be larger or smaller than the combined surfaces and in this case a 2.0 angstrom expanded surface was employed.

A 3 dimensional database containing the cipro analogs and a series of antidepressants, sedatives, estrogens, androgens was searched using the cipro search engine and the program Unity (Tripos Associates, St. Louis, Mo.). Hits from the search (Table 1) included the cipro analogs used to construct the search engine as well as cinoxacin, an active structurally related antibiotic which was not used in constructing the engine. Hits from the search engine were specific as shown by the lack of hits of the antidepressants, sedatives, estrogens or androgens contained in the database. When the National Cancer Institutes (NCI) 3-dimensional database provided by Tripos was searched, a total of 1662 hits of 117,649 compounds were observed. A particularly interesting hit is the structurally unrelated antibiotic ampicillin which has similar activity against Anthrax (FIGS. 12, 13). When the antidepressant, sedative, estrogen and androgen search engines were used to search the database, few hits were observed, further indicating cross validation of the cipro and other search engines (Table 1)

### EXAMPLE 7

Evaluation of Substances for Predicted Anti-Angiogenic Biological Activity

The following seven molecules of known anti-angiogenic biological activity were used to construct the anti-angiogenic search engine (spatials, Connolly surface and nucleic acid exclusion volume shape): 2-ethoxyestradiol, 2-methoxy-17(20)-methylene-estradiol, 2-methoxy-estra-1,3,5(10)9(11)-tetraene-3,17,β-diol, 2-methoxy-16α-methylestradiol, 2-methoxy-19-norpregan-1,3,5(10)17(20)-tetraene-3-ol (Z), 2-(1′-propynylestradiol) and 2-methoxyestradiol These anti-angiogenic molecules were docked into spaces between base pairs in double stranded DNA using a sequence (5′-dTdG-3′5′-dCdA-3′) and partially unwound conformation which best forms a complex with the ligands. The spatial was created from the position of the heteroatoms on the DNA that form hydrogen bonds to these anti-angiogenic compounds, i.e. two electrostatic points corresponding to the 3 hydroxyl group and the 17β hydroxy group of the anti-angiogenic compounds which form stereospecific linkages to the phosphate groups on adjacent DNA strands. In addition, a third spatial was created from water molecules connecting the N-7 of adenine and the oxygen atom at the 3 position of the anti-angiogenic compounds (i.e. 2-methoxyestradiol) via hydrogen bonding linkages. The three spatials are constraints into which appropriate hydrogen bonding heteroatoms of functional groups on a candidate structure must fit to be considered a hit by the search engine. Partial matches to two of the three spatials have also been employed as constraints in the anti-angiogenic search engine. The surface of the partially unwound DNA into which the molecules were docked was used as an excluded volume i.e., a candidate molecule is not permitted to fit into this space. A Connolly surface of the composite surfaces of these sedatives was created from the composite of all of the active molecules. This surface was created initially at a 3 angstroms distance beyond, or greater than, the Connolly surface. Databases were searched for compounds that would fit inside this Connolly surface, did not violate the excluded volume surface and possessed heteroatoms that fit within the spatials emanating from the heteroatoms on DNA and the water bridge. It is also possible to use various combinations of the spatials and Connolly surfaces either independently and/or in combination with the excluded volume surface to search various databases.

The antiangiogenic search engine was then employed to search databases containing a variety of molecular structures. In these searches the extended volume for the Connolly surface was initially 3.0 angstroms. The number of starting conformations for molecules to be searched was set at 0. All of the antiangiogenic standards used to create the search engine were identified by the search. In addition, thalidomide, EM-12, resveratrol and quercetin were identified by the search. Thalidomide was not used in creation of the search engine and does not possess a steroid skeleton unlike the standards used to create the search engine. Thalidomide is known to have anti-angiogenic activity. Resveratrol and quercetin are naturally occurring plant compounds that are structurally unrelated to the steroid standards but are anti-angiogenic.

### EXAMPLE 8

Evaluation of Substances for Predicted Erectile Biological Activity and Treatment of Impotence

The following molecule of known penile erectile biological activity useful for the treatment of impotence was used to construct the anti-impotence search engine (spatials, Connolly surface and nucleic acid exclusion volume shape): dehydroepiandrosterone (DHEA). This anti-impotence molecule was docked into spaces between base pairs in double stranded DNA using a sequence (5′-dTdG-3′5′-dCdA-3′) and partially unwound conformation which best forms a complex with the ligands. The spatial was created from the position of the heteroatoms on the DNA that form hydrogen bonds to DHEA, i.e. two electrostatic points corresponding to the 3 β hydroxy and the 17 keto group of the anti-impotence molecules which forms stereospecific linkages to the phosphate groups on adjacent DNA strands. The surface of the partially unwound DNA into which the molecule was docked was used as an excluded volume i.e., a candidate molecule is not permitted to fit into this space. A Connolly surface of the anti-impotence molecule DHEA was created. This surface was created initially at a 3 angstroms distance beyond, or greater than, the Connolly surface. Databases were searched for compounds that would fit inside this Connolly surface, did not violate the excluded volume surface and possessed heteroatoms that fit within the spatials emanating from the heteroatoms on DNA. It is also possible to use various combinations of the spatials and Connolly surfaces either independently and/or in combination with the excluded volume surface to search various databases.

The anti-impotence search engine was then employed to search databases containing a variety of molecular structures. In these searches the extended volume for the Connolly surface was initially 3.0 angstroms. The number of starting conformations for molecules to be searched was set at 0. The DHEA standard used to create the search engine hit the search. In addition, arginine, lysine, cyclic GMP, moxysylyte, xanthinol and arbutin were identified by the search. None of these compounds was used in creation of the search engine and none possesses a steroid skeleton unlike the DHEA which was used to create the search engine. Arginine, lysine and cyclic GMP are naturally occurring compounds known to be active in alleviating erectile dysfunction. Moxysylyte is a known drug, which also alleviates erectile dysfunction. Xanthinol is a vasodilator which is employed to treat impotence. Arbutin is a plant derived natural product present which is a component of certain nutraceutical preparations purported to be active in treating impotence.

### EXAMPLE 9

Evaluation of Substances for Predicted Carcinogenic Biological Activity

The following molecule of known to have carcinogenic biological activity was used to construct the carcinogenic search engine (spatials, Connolly surface and nucleic acid exclusion volume shape): benzpyrene oxide. This carcinogenic molecule was docked into spaces between base pairs in double stranded DNA using a sequence (5′-dTdG-3′5′-dCdA-3′) and partially unwound conformation which best forms a complex with the ligands. The spatial was created from the position of the heteroatom on the benzpyrene that has the potential to form a covalent linkage to DNA i.e., an atom corresponding to the location of the highly reactive epoxide oxygen of benzpyrene that can interact with the N-7 of guanine. The surface of the partially unwound DNA into which the molecule was docked was used as an excluded volume i.e., a candidate molecule is not permitted to fit into this space. A Connolly surface of the carcinogen benzpyrene oxide was created. This surface was created initially at a 3 angstroms distance beyond, or greater than, the Connolly surface. Databases were searched for compounds that would fit inside this Connolly surface, did not violate the excluded volume surface and possess a heteroatom that fit within the spatial. It is also possible to use various combinations of the spatials and Connolly surfaces either independently and/or in combination with the excluded volume surface to search various databases. In addition, the spatial can be defined in a manner to limit hits to only those molecules containing reactive atoms e.g. oxygens of epoxides.

The carcinogenic search engine was then employed to search databases containing a variety of molecular structures. In these searches the extended volume for the Connolly surface was initially 3.0 angstroms. The number of starting conformations for molecules to be searched was set at 0. The benzpyrene standard used to create the search engine hit the search. In addition, eupatoroxin, callicarpone and picrotoxin were identified by the search. None of these molecules was used in creation of the search engine and none possesses a benzpyrene skeleton, unlike the benzpyrene oxide which was used to create the search engine. Eupatoroxin is a phytochemical that is cytotoxic. Callicarpone is a natural product present in an aquatic plant that kills fish. Picrotoxin is also an natural product from plants known to be toxic to humans.

### EXAMPLE 10

Evaluation of Substances for Predicted Glucocorticoid Biological Activity

Cortisol, a molecule of known glucocorticoid biological activity was used to construct the glucocorticoid search engine (spatials). A x-ray crystallographic complex of the glucocorticoid receptor DNA binding domain bound to the glucocorticoid hormone response element was employed. The glucocorticoid was docked into spaces between base pairs in double stranded DNA using the sequence (5′-dTdG-3′5′-dCdA-3′) within the hormone response element bound to the receptor protein and a partially unwound conformation which best forms a ternary complex with the ligand. The spatials were created from the positions of the heteroatoms on the DNA/receptor complex that have the potential to form a hydrogen bonds to cortisol, i.e. the 3 and 20 carbonyl groups of cortisol which form hydrogen bonds to protonated phosphate oxygens on adjacent DNA strands, the 21 hydroxyl group which forms a hydrogen bond to lysine 490 and the 17α hydroxyl group which forms a hydrogen bond to arginine 466. The NCI Database was searched for molecules that would fit the spatials. In this manner, 3,037 compounds hit the search.

### EXAMPLE 11

High Enrichment Rate of Molecules Identified Using the Estrogen Search Engine

The estrogen search engine was employed to evaluate the database of 1470 stereochemically accurate structures whose uterotropic (estrogenic) biological activity was reported by the National Institutes of Health (N.I.H.) (Hilgar, A. G. & Palmore Jr., J., authors, and Hilgar, A. G. and Trench, L.C. eds., Part VI: The Uterotropic Evaluation of Steroids and Other Compounds-Assay 2, U.S. Department of Health, Education and Welfare, N.I.H., Endocrine Bioassay Data Entry Nos., 4324-5962, Issue 3, June 1968). This massive study evaluated the uterotropic activity of 745 steroids and 360 non-steroids relative to the reference molecule estrogen. The estrogen search engine of the present invention was employed to evaluate each of these molecules. In cases where stereochemistry was unassigned or ambiguous, all appropriate isomers and analogs were constructed and placed in the database resulting in 1470 structures. Of the 1470 structures, 18 structures (exclusive of prodrugs) possessed activity ranging from 0.3 to 300% relative to the index standard estradiol; 9 of the structures had activity 30 to 300% of estradiol. In an optimum search using a 0.35 Angstrom Connolly added volume, 32 hits were obtained with 16 having activity. All 9 structures with activity 30 to 300% were identified by the search. The number of prodrugs in the database was 59, of which none was identified by the estrogen search engine. In such cases, when the biologically active metabolite of the prodrug was in the database, it was identified by the search engine.

FIG. 14 demonstrates the average in vivo estrogenic activity of molecules identified with the estrogen search engine in relationship to the number of steps performed using the estrogenic search engine. The data demonstrate that the estrogen search engine not only identifies estrogenic molecules, but also that the relative biological activity of the identified molecules is correlated with application of successive steps in the use of the estrogen search engine. Accordingly, increased biological activity is correlated with application of successive steps in the use of the estrogen search engine. Molecules associated with a specific step, for example those molecules identified by the reduction in the included volume from one angstrom distance to another, are likely to possess a specific range of biological activity and may be useful for achieving a desired therapeutic efficacy.

The estrogen search engine can be applied in a series of steps that are incrementally applied to narrow the search parameters. In step 1, only electrostatic spatials are employed followed by step 2 in which both the spatials and excluded volume are used. In step 3, spatials, excluded volume and the largest appropriate Connolly surfaces are employed i.e. 3.0 Angstrom. Steps 4 through 18 are incremental decreases in the Connolly surface from 3.0 Angstroms to 0.25 Angstroms.

FIG. 15 demonstrates the enrichment rate (y-axis-total number of structures divided by the number of molecules (hits) containing biologically active estrogenic molecules) using the estrogen search engine as a function of the number of steps used in searching with estrogen search engine. The optimal parameters included a 0.35 angstrom included volume which was associated with an enrichment rate greater than 40 fold (32 hits of 1470 stereochemically accurate structures whose biological activities were reported by the National Institutes of Health. These data support the validity and predictive ability of the search engine to correctly identify and predict estrogenic molecules and also their relative efficacy.

FIGS. 14 and 15 are derived from the same study and show that the search not only identifies which structures are likely to be active (FIG. 15) but also concentrates the most highly active structures (FIG. 14) i.e. the average biological activity per structure increases.

These results demonstrate the rapid and efficient identification of molecules that either are known to possess the specific biological activity searched for or are candidates for further biological testing and evaluation for possessing the specific biological activity. The results further demonstrate that the present invention rapidly produces a relatively short list of molecules for further biological testing for possessing one or more biological activities. The present invention is also capable of predicting the relative biological activity of a molecule.

TABLE 1

| | | | | | Anthrax | Carcinogenic | | |
|---|---|---|---|---|---|---|---|---|
| | | | | | Antibiotic | (Benzopyrene | Antiangiogenesis | Impotence |
| | Antidepressant | Sedative | Androgen | Estrogen | (Cipro) | Oxide) | (2ME) | (DHEA) |
| | Search | Search | Search | Search | Search | Search | Search | Search |
| Compounds Searched | Engine | Engine* | Engine | Engine | Engine | Engine | Engine | Engine |
| Antidepressants | | | | | | | | |
| Imipramine (Tofranil) | +STD | − | − | − | − | | − | |
| Fluoxetine (Prozac) | +STD | +PM | − | − | − | | − | |
| Sertraline (Zoloft) | +STD | − | − | − | − | | − | |
| Maprotiline | +STD | − | − | − | − | | − | |
| Amitriptyline (Elavil) | +STD | − | − | − | − | | − | |
| Nomifensin | +STD | − | − | − | − | | − | |
| Iprindole | +STD | − | − | − | − | | − | |
| Chlomipramine (Anafranil) | +STD | − | − | − | − | | − | |
| Fantridone | + | +PM | − | − | − | | − | |
| Bupropion | + | +PM | − | − | − | | − | |
| Reboxetine | + | − | − | − | − | | − | |
| Venlafaxine | + | − | − | − | − | | − | |
| Fluvoxamine | + | − | − | − | − | | − | |
| Paroxetine (Paxil) | + | + | − | − | − | | − | |
| Sedatives | | | | | | | | |
| Alphaxalone | − | +STD | − | − | − | | − | |
| 3α5α-Tetrahydroprogesterone | − | +STD PM | − | − | − | | − | |
| 3β5α-Tetrahydroprogesterone | − | +STD PM | − | − | − | | − | |
| Ganaxolone | − | +STD PM | − | − | − | | − | |
| Adenosine | +/− | + | − | +/− | − | | +2 Ang | |
| Brotizolam | − | +PM | − | − | − | | − | |
| Melatonin | +/− | + | − | − | − | | − | |
| Amobarbital | + | +PM | − | − | − | | − | |
| Bultalbital | + | +PM | − | − | − | | − | |
| Δ-9-Tetrahydrocannabiol | − | +PM | − | − | − | | − | |
| Cyclopenol | +/− | + | − | − | − | | − | |
| Etifoxine | + | +PM | − | − | − | | − | |
| Thalidomide | +*** | +PM**** | − | − | − | | +PM | |
| Androgens | | | | | | | | |
| Testosterone | − | − | +(STD) | − | − | | − | |
| 7α-Methyltestosterone | − | − | +(STD) | − | − | | − | |
| 19-Nortestosterone | − | − | +(STD) | − | − | | − | |
| 7α-Methyl−19-Nortestosterone | − | − | +(STD) | − | − | | − | |
| 5α-Dihydrotestosterone | − | − | +(STD) | − | − | | − | |
| 7α-methyl-5α- | − | − | +(STD) | − | − | | | |
| Dihydrotestosterone | | | | | | | | |
| 5α-Dihydro-19-Nortestosterone | − | − | +(STD) | − | − | | − | |
| 17α-Methyl-5α- | − | − | +(STD) | − | − | | − | |
| Dihydrotestosterone | | | | | | | | |
| 7α-Methyl-19-Nor-5α- | − | − | +(STD) | − | − | | − | |
| Dihdyrotestosterone | | | | | | | | |
| 17α-Methyl-19-Nor-5α- | − | − | +(STD) | − | − | | − | |
| Dihdyrotestosterone | | | | | | | | |
| 7α-Methyl-17α-Methyl- | − | − | +(STD) | − | − | | − | |
| 19-Nor-5α- | | | | | | | | |
| Dihdyrotestosterone | | | | | | | | |
| Mibolerone (7α-Methyl-17α- | − | − | + | − | − | | − | |
| Methyl- | | | | | | | | |
| 19-Nortestosterone) | | | | | | | | |
| Estrogens | | | | | | | | |
| Estradiol | − | − | − | +STD | − | | − | |
| 11β-Methoxyestradiol | − | − | − | +STD | − | | − | |
| 11β-Formoxyestradiol | − | − | − | +STD | − | | − | |
| 11β-Acetoxyestradiol | − | − | − | +STD | − | | − | |
| Estradiol-11β-Nitroester | − | − | − | +STD | − | | − | |
| 7α-Methylestradiol-11β- | − | − | − | +STD | − | | − | |
| Nitroester | | | | | | | | |
| 17α-Ethynylestradiol | − | − | − | +STD | − | | − | |
| 17α-Chloroethnylestradiol | − | − | − | +STD | − | | − | |
| Moxestrol (11β-Methoxy-17α- | − | − | − | +STD | − | | − | |
| Ethynylestradiol) | | | | | | | | |
| 17α-Iodovinyl-(Z)-11β- | − | − | − | +STD | − | | − | |
| Chloromethylestradiol | | | | | | | | |
| PDC-7(11β-Methoxy-7α- | − | − | − | + | − | | − | |
| Methylestradiol) | | | | | | | | |
| Trans-Diethylstilbestrol | − | − | − | + | − | | − | |
| Genistein (Phytoestrogen) | − | − | − | + | − | | − | |
| Equol (Phytoestrogen) | − | − | − | + | − | | − | |
| Daidzein (Phytoestrogen) | − | − | − | + | − | | − | |
| Zearalanol (Phytoestrogen) | − | − | − | + | − | | − | |
| Horeau's Acid | − | − | − | + | − | | − | |
| Indenestrol | − | − | − | + | − | | − | |
| Anthrax Antiobiotics***** | | | | | | | | |
| Ciprofloxacin | − | − | − | − | +STD | | − | |
| Nalidixic Acid | − | − | − | − | +STD PM | | − | |
| Fleroxacin | − | − | − | − | +STD | | − | |
| Gatifloxacin | − | − | − | − | +STD | | − | |
| Levofloxacin | − | − | − | − | +STD | | − | |
| Lomefloxacin | − | − | − | − | +STD | | − | |
| Moxifloxacin | − | − | − | − | +STD | | − | |
| Norfloxacin | + | − | − | − | +STD | | − | |
| Perfloxacin | − | − | − | − | +STD | | − | |
| Sparfloxacin | − | − | − | − | +STD | | − | |
| Trovafloxacin | − | − | − | − | +STD | | − | |
| Cinoxacin | − | − | − | − | +PM | | − | |
| Ampicillin | − | +/− | − | +/− | + | | − | |
| Carcinogens (Benzpyrene Oxide | | | | | | | | |
| Class) | | | | | | | | |
| Benzapyrene oxide | | | | | | +STD | − | |
| Eupatoroxin (20071-51-6) | | | | | | + | | |
| Callicarpone (5938-11-4) | | | | | | + | | |
| in acquatic | | | | | | | | |
| weed/kills fish | | | | | | | | |
| Swazine (38763-74-5) alkaloid | | | | | | + | | |
| Picrotoxinin | | | | | | + | | |
| Antiangiogenesis (2ME Class) | | | | | | | | |
| 2-Ethoxyestradiol | | | | | | | +STD | |
| 2-Methoxyestradiol | | | | | | | +STD | |
| Δ-9-11-2-Methoxyestradiol | | | | | | | +STD | |
| 16α-Methyl-2-Methoxyestradiol | | | | | | | +STD PM | |
| 2-Methoxyestratriene-3-ol-17- | | | | | | | +STD PM | |
| exomethylene | | | | | | | | |
| 2-Methoxyestratriene-3-ol-17- | | | | | | | +STD PM | |
| exoethylene (Z) | | | | | | | | |
| 1-(1′-Propynyl)-2- | | | | | | | +STD | |
| Methoxyestradiol | | | | | | | | |
| BTB 09937 Maybridge | | | | | | | + | |
| BTB 12807 Maybridge | | | | | | | + | |
| JFD 01053 Maybridge | | | | | | | + | |
| JFD 02820 (Coniferyl | | | | | | | +2.0 Ang | |
| Alcohol;cf. Curcumin) | | | | | | | | |
| NRB 03608 Maybridge | | | | | | | + | |
| Ellagic Acid | | | | | | | +1.5 Ang | |
| Catechin | | | | | | | +1.0 Ang | |
| Quercetin (nsc 09219; | | | | | | | +1.5 Ang | |
| all databases hit) | | | | | | | | |
| PDC 50 | | | | | | | +1.0 Ang | |
| PDC 45 | | | | | | | +0.5 Ang | |
| PDC 46 | | | | | | | +0.7 Ang | |
| PDC 41 | | | | | | | +0.7 Ang | |
| Resveratrol (3,5,4′- | | | | | | | +0.7 Ang | |
| Trihydroxy(trans)stilbene) | | | | | | | PM | |
| nsc 76988 | | | | | | | +1.5 Ang | |
| (1Endocrinebioassay) | | | | | | | | |
| nsc 56293 2S | | | | | | | +1.5 Ang | |
| (1Endocrinebiossay) | | | | | | | | |
| nsc 56293 2R | | | | | | | +2.0 Ang | |
| (1Endocrinebiossay) | | | | | | | | |
| nsc 24233 (7s 10s) | | | | | | | +1.5 Ang | |
| (1Endocrinebioassay) | | | | | | | | |
| nsc 32653 (meso) | | | | | | | +2.0 Ang | |
| (1Endrocrinebioassay) | | | | | | | | |
| nsc 32082 (meso) | | | | | | | +2.0 Ang | |
| (1Endrocrinebioassay) | | | | | | | | |
| Thalidomide | | | | | | | +3.0 Ang | |
| | | | | | | | PM | |
| EM-12 | | | | | | | +3.0 Ang | |
| | | | | | | | PM | |
| Impotence Drugs & Candidates | | | | | | | | |
| DHEA | | | | | | | | +STD 1.7 |
| | | | | | | | | Ang |
| Arginine | | | | | | | | +1.5 Ang |
| Lysine | | | | | | | | + |
| Marmesin (Celery) | | | | | | | | + |
| NIH CAS 5407-46-5 | | | | | | | | +.7 Ang |
| (Xanthenone Analog) | | | | | | | | |
| NIH CAS 529-49-7 | | | | | | | | +.7 Ang |
| Xanthone Analog) | | | | | | | | |
| NIH CAS 53254-99-2 | | | | | | | | +.7 Ang |
| Cintronellal | | | | | | | | + |
| Desthiobiotin | | | | | | | | + |
| Brazilin | | | | | | | | + |
| Cysteine | | | | | | | | + |
| Penicllin G | | | | | | | | + |
| Coumestrol | | | | | | | | + |
| Ellagic Acid | | | | | | | | +1.0 Ang |
| Desaminoarginine | | | | | | | | + |
| Europine | | | | | | | | + |
| Elymoclavine | | | | | | | | + |
| Papaverol | | | | | | | | + |
| Laudanosoline | | | | | | | | + |
| Glycin | | | | | | | | + |
| Dehydrobiotin | | | | | | | | + |
| Pantothenic Acid (Vitamin B5) | | | | | | | | +1.5 Ang |
| Convolanine | | | | | | | | + |
| Narciclasine | | | | | | | | + |
| ε-Amiinocaproic Acid | | | | | | | | + |
| Phloretic Acid | | | | | | | | + |
| 6ab-apormorphine-10,11-diol | | | | | | | | + |
| Trihydroxyxanthenone | | | | | | | | + |
| NSC 66209 | | | | | | | | |
| Cyclic GMP | | | | | | | | +1.5 Ang |
| SK-331-A (purine vasodilator) | | | | | | | | + |
| CAS 437-74-1 | | | | | | | | |
| neo-Vasophylline (purine | | | | | | | | + |
| analog) brochodilator | | | | | | | | |
| Hydantoin Analogs | | | | | | | | + |
| (NSC 23788; 3985) | | | | | | | | |
| Arbutin (Damiana; Turnea | | | | | | | | +1.0 Ang |
| Diffusa) | | | | | | | | |
| CAS 497-76-7 | | | | | | | | |
| HomoArbutin NCI CAS | | | | | | | | + |
| 25712-94-1 Bearberry | + | | | | | | | |
| Moxisylyte NCI CAS 964-52-3 | | | | | | | | +1.7 Ang |
| erectile dysfunction | | | | | | | | |
| Desmethylmoxisylyte | | | | | | | | +1.5 Ang |
| Quercetin NCI CAS 6270-97-9 | | | | | | | | +1.7 Ang |
| Salazinic Acid NCI CAS | | | | | | | | +1.7 Ang |
| 521-39-1 | | | | | | | | |
| Luteolin (Ginko) | | | | | | | | +3.0 Ang |
| Caffeic Acid | | | | | | | | +3.0 Ang |
| Dyphylline (Merck) | | | | | | | | +3.0 Ang |
| Xanthinol (vasodilator) | | | | | | | | +3.0 Ang |
| Triac | | | | | | | | +3.0 Ang |
| NCI Database Hits (117,649) | | | | | 1662 | | | |
| 1Androgenbioassayunitydb | | | | | | | @ −1.0 Ang | |
| Hits (454) | | | | | | | | |
| Maybridge Database Hits | | | | | | | | |
| Parameters | | | | | | | | |
| Surface Volume In Angstroms | 0.7 | 1.5 | 1.0 | 1.5 | 2 | | 0.3 | |
| Number Of Starting | 20 | Off | Off | 20 | Off | | Off | |
| Conformations | | (default) | (default) | | (default) | | | |
| Number Of Electrostatic Points | 1 | 3 | 2 | 2 | 2 | | 3 | |
| Rules (donor/acceptor | no | no | no | no | yes | | no | |
| definitions) | | | | | | | | |
| STD = Molecules Used | | | | | | | | |
| To Create Search Engine | | | | | | | | |

*Ligand Acceptor Assigned As Not Phenol
Phenolate In Full Constraint Search
PM = Partial Match Constraints (2 of 3 Electrostatic Points)
+/− = Hits But With Different Electrostatic Atoms Than Standards
The hits above indicate potential activities of compounds; quantitation of the degree of fit of a given hit relative to an index compound can provide further validation of a given activity
***R enantiomer only hits at 0.7 and 20 Conf
****S enantiomer good fit; R enantiomer poor fit
*****protonated amines; carboxylate anion

TABLE 2

| | | | | | Number |
|---|---|---|---|---|---|
| | | | | Number | Of |
| | | | | Of Hits | Hits Of |
| | | | | Of NCI | Maybridge |
| | Number | | Connolly | Database | Database |
| | Of | Excluded | Surface In | (117,649 | (61,184 |
| Search Engine | Spatials | Volume | Angstroms | Structures) | Structures) |
| Antidepressant | 1 | yes | 3 | 63,647 | 31,618 |
| Antidiabetic | 1 | none | none | 79,613 | |
| Antidiabetic | 1 | yes | 1 | 1,650 | |
| Progestin | 2 | none | none | 15,593 | |
| Progestin | 2 | yes | none | 5,999 | |
| Thyroid | 2 | none | none | 7,784 | |
| Estrogen | 2 | none | none | 11,181 | |
| Estrogen | 2 | yes | none | 7,655 | |
| Androgen | 2 | none | none | 15,133 | |
| Androgen | 2 | yes | 2 | 2,122 | 423 |
| Bone | 3 | none | none | 645 | |
| Sedative | 3 | yes | none | 13,051 | |
| Sedative | 3 | yes | 3 | 4,626 | 2,531 |
| Sedative | 3 | yes | 1.7 | 3,280 | 1,519 |
| Sedative | 3 | yes | 1.4 | 2,817 | 982 |
| Sedative | 3 | yes | 1 | 1,609 | 494 |
| Sedative | 3 | yes | 0.7 | 957 | |
| Glucocorticoid | 5 | yes | none | 3,037 | |
| Cipro | 2 | yes | 2 | 1662 | |

All patents, publications and abstracts cited above are incorporated herein by reference in their entirety. It should be understood that the foregoing relates only to preferred embodiments of the present invention and that numerous modifications or alterations may be made therein without departing from the spirit and the scope of the present invention as defined in the following claims.

1. A method of creating a search engine, comprising:
selecting a binding site within nucleic acid;
selecting a molecule having a known biological activity that fits with the binding site; and
defining search criteria forming part of the search engine, the search criteria comprising at least one of the following:
(1) docking the molecule having the known biological activity with the binding site by evaluating electrostatic interactions between the molecule and the binding site within the nucleic acid, the electrostatic interactions defining a spatial;
(2) defining an included volume based on surfaces of the molecule that fit within the nucleic acid binding site; and
(3) defining an excluded volume based on surfaces of the binding site that cannot be penetrated;
the search engine for using at least one of the spatial, the included volume, or the excluded volume in evaluating a potential biological activity of a molecule having an unknown biological activity.

2. The method as set forth in claim 1, wherein the spatial defines locations and charge characteristics of hydrogen bonds formed between the molecule having the known biological activity and the binding site within nucleic acid.

3. The method as set forth in claim 1, wherein the included volume comprises a Connolly surface.

4. The method as set forth in claim 1, wherein the excluded volume comprises a van der Waals surface of DNA.

5. The method as set forth in claim 1, wherein the molecule having the known biological activity comprises a plurality of molecules having the known biological activity.

6. The method as set forth in claim 1, further comprising using the search engine to evaluate the potential biological activity of the molecule having the unknown biological activity.

7. The method as set forth in claim 1, further comprising adjusting a distance within the included volume.

8. The method as set forth in claim 1, further comprising setting a number of conformations that the search engine performs in evaluating the molecule having the unknown biological activity.

9. The method as set forth in claim 1, wherein the search engine is configured to evaluate the molecule having the unknown biological activity using the spatial.

10. The method as set forth in claim 1, wherein the search engine is configured to evaluate the molecule having the unknown biological activity using the spatial followed by excluded volume.

11. The method as set forth in claim 1, wherein the search engine is configured to evaluate the molecule having the unknown biological activity using the spatial followed by included volume.

12. The method as set forth in claim 1, wherein the search engine is configured to evaluate the molecule having the unknown biological activity using the spatial followed by excluded volume followed by included volume.

13. The method as set forth in claim 1, wherein the search engine is configured to evaluate the molecule having the unknown biological activity using the included volume followed by the excluded volume.

14. A method of using a search engine to evaluate a potential biological activity of a molecule having an unknown biological activity, comprising:
selecting the search engine based on the biological activity to be evaluated, the search engine being formed by:
(a) selecting a binding site within nucleic acid;
(b) selecting a molecule having a known biological activity that fits with the binding site; and
(c) defining search criteria forming part of the search engine, the search criteria comprising at least one of the following:
(1) docking the molecule having the known biological activity with the binding site by evaluating electrostatic interactions between the molecule having the known biological activity and the binding site within the nucleic acid, the electrostatic interactions defining a spatial;
(2) defining an included volume based on surfaces of the molecule having the known biological activity that fit within the nucleic acid binding site; and
(3) defining an excluded volume based on surfaces of the binding site that cannot be penetrated;
selecting the molecule having the unknown biological activity; and
running the search engine using at least one of the spatial, the included volume, or the excluded volume to determine the potential biological activity of the molecule having the unknown biological activity.

15. The method as set forth in claim 14, wherein selecting the molecule having the unknown biological activity comprises selecting a database of molecules having the unknown biological activity.

16. The method as set forth in claim 14, further comprising configuring the search engine.

17. The method as set forth in claim 16, wherein configuring comprises adjusting tolerances associated with the included volume.

18. The method as set forth in claim 14, wherein running the search engine comprises running the search engine to evaluate the molecule having the unknown biological activity using the spatial.

19. The method as set forth in claim 14, wherein running the search engine comprises running the search engine to evaluate the molecule having the unknown biological activity using the spatial followed by excluded volume.

20. The method as set forth in claim 14, wherein running the search engine comprises running the search engine to evaluate the molecule having the unknown biological activity using the spatial followed by included volume.

21. The method as set forth in claim 14, wherein running the search engine comprises running the search engine to evaluate the molecule having the unknown biological activity using the spatial followed by excluded volume followed by included volume.

22. The method as set forth in claim 14, wherein running the search engine comprises running the search engine to evaluate the molecule having the unknown biological activity using the included volume followed by the excluded volume.

23. A system for creating a search engine, comprising:
means for selecting a binding site within nucleic acid;
means for selecting a molecule having a known biological activity that fits with the binding site; and
means for defining search criteria forming part of the search engine, the search criteria comprising at least one of the following:
(1) means for defining a spatial by docking the molecule having the known biological activity with the binding site to evaluate electrostatic interactions between the molecule and the binding site within the nucleic acid, the electrostatic interactions defining the spatial;
(2) means for defining an included volume based on surfaces of the molecule that fit within the nucleic acid binding site; and
(3) means for defining an excluded volume based on surfaces of the binding site that cannot be penetrated;
the search engine for using at least one of the spatial defining means, the included volume defining means, or the excluded volume defining means in evaluating a potential biological activity of a molecule having an unknown biological activity.

24. A computer-readable medium for storing software for use in performing a method of creating a search engine, the method comprising:
selecting a binding site within nucleic acid;
selecting a molecule having a known biological activity that fits with the binding site; and
defining search criteria forming part of the search engine, the search criteria comprising at least one of the following:
(1) docking the molecule having the known biological activity with the binding site by evaluating electrostatic interactions between the molecule and the binding site within the nucleic acid, the electrostatic interactions defining a spatial;
(2) defining an included volume based on surfaces of the molecule that fits within the nucleic acid binding site; and
(3) defining an excluded volume based on surfaces of the binding site that cannot be penetrated;
the search engine for using at least one of the spatial, the included volume, or the excluded volume in evaluating a potential biological activity of a molecule having an unknown biological activity.

25. A system for using a search engine to evaluate a potential biological activity of a molecule having an unknown biological activity, comprising:
means for selecting the search engine based on the biological activity to be evaluated, the search engine being formed by:
(a) selecting a binding site within nucleic acid;
(b) selecting a molecule having a known biological activity that fits with the binding site; and
(c) defining search criteria forming part of the search engine, the search criteria comprising at least one of the following:
(1) docking the molecule having the known biological activity with the binding site by evaluating electrostatic interactions between the molecule having the known biological activity and the binding site within the nucleic acid, the electrostatic interactions defining a spatial;
(2) defining an included volume based on surfaces of the molecule having the known biological activity that fit within the nucleic acid binding site; and
(3) defining an excluded volume based on surfaces of the binding site that cannot be penetrated;
means for selecting the molecule having the unknown biological activity; and
means for running the search engine using at least one of the spatial, the included volume, or the excluded volume to determine the potential biological activity of the molecule having the unknown biological activity.

26. The system as set forth in claim 25, further comprising means for accessing a database containing the molecule having the unknown biological activity.

27. The system as set forth in claim 26, further comprising the database.

28. A computer-readable medium for storing software for use in performing a method of using a search engine to evaluate a potential biological activity of a molecule having an unknown biological activity, the method comprising:
selecting the search engine based on the biological activity to be evaluated, the search engine being formed by:
(a) selecting a binding site within nucleic acid;
(b) selecting a molecule having a known biological activity that fits with the binding site; and
(c) defining search criteria forming part of the search engine, the search criteria comprising at least one of the following:
(1) docking the molecule having the known biological activity with the binding site by evaluating electrostatic interactions between the molecule having the known biological activity and the binding site within the nucleic acid, the electrostatic interactions defining a spatial;
(2) defining an included volume based on surfaces of the molecule having the known biological activity that fit within the nucleic acid binding site; and
(3) defining an excluded volume based on surfaces of the binding site that cannot be penetrated;
selecting the molecule having the unknown biological activity; and
running the search engine using at least one of the spatial, the included volume, or the excluded volume to determine the potential biological activity of the molecule having the unknown biological activity.

29. A method of designing a new molecule for a biological activity, comprising:
selecting a binding site within nucleic acid;
selecting an existing molecule having a known biological activity that fits with the binding site;
defining a molecular skeleton formed from at least one of the following:
(1) a spatial defined by docking the existing molecule having the known biological activity with the binding site to evaluate electrostatic interactions between the existing molecule and the binding site within the nucleic acid, the electrostatic interactions defining the spatial;
(2) an included volume defined by surfaces of the existing molecule that fit within the nucleic acid binding site; and
(3) an excluded volume defined by surfaces of the binding site that cannot be penetrated;
selecting at least two functional groups from a plurality of functional groups;
combining functional groups that were selected to form the new molecule; and
checking if the new molecule fits along the molecular skeleton;
wherein the new molecule has a potential for the biological activity if the new molecule fits along the molecular skeleton.

30. The method as set forth in claim 29, wherein selecting at least two functional groups comprises selecting more than two functional groups to form the new molecule.

31. The method as set forth in claim 29, wherein selecting at least two functional groups comprises selecting chemical structures.

32. The method as set forth in claim 29, wherein defining a molecular structure comprises forming the molecular skeleton from the spatial.

33. The method as set forth in claim 29, wherein defining a molecular structure comprises forming the molecular skeleton from the spatial and the included volume.

34. The method as set forth in claim 29, wherein defining a molecular structure comprises forming the molecular skeleton from the spatial and the excluded volume.

35. The method as set forth in claim 29, wherein defining a molecular structure comprises forming the molecular skeleton from the spatial, the included volume, and the excluded volume.

36. The method as set forth in claim 29, wherein defining a molecular structure comprises forming the molecular skeleton from the excluded volume and the included volume.

37. The method as set forth in claim 29, wherein selecting at least two functional groups and combining functional groups comprises:
combining the at least two functional groups to form a first portion of the new molecule;
checking if the first portion of the new molecule fits along a corresponding first portion of the molecular skeleton;
selecting at least one other functional group;
combining the at least one other functional group with the first portion of the new molecule to form the new molecule.

38. The method as set forth in claim 29, wherein selecting at least two functional groups and combining functional groups comprises:
combining the at least two functional groups to form a first portion of the new molecule;
selecting at least one other functional group; and
combining the at least one other functional group with the first portion of the new molecule to form the new molecule.
